(19) United States
(12) Patent Application Publication
(10) Pub. No.: US 2020/0249891 A1
(43) Pub. Date: Aug. 6, 2020

(54) IMAGE FORMING APPARATUS, INFORMATION PROCESSING METHOD, AND STORAGE MEDIUM

(71) Applicant: CANON KABUSHIKI KAISHA, Tokyo (JP)

(72) Inventor: Shuuhei Kawakami, Higashiyamato-shi (JP)

(21) Appl. No.: 16/775,988

(22) Filed: Jan. 29, 2020

(30) Foreign Application Priority Data
Feb. 5, 2019 (JP) 2019-018618

(51) Int. Cl. G06F 3/12

(52) U.S. Cl. CPC G06F 3/1273; G06F 3/1259; G06F 3/1253

(57) ABSTRACT

An object is to provide a history display that facilitates selecting a function to be re-executed. A document image is generated based on a job setting when a function is executed and a job result when the function is executed. The job setting and the document image are displayed as a history of the function.

### BACKGROUND

### Field of the Disclosure

The present disclosure relates to an image forming apparatus, an information processing method, and a storage medium.

### Description of the Related Art

Multifunctional image forming apparatuses have a plurality of functions, such as a copy function, a printer function, and a scanner function. Image forming apparatuses conventionally have a menu screen on which buttons for selecting functions to be used are listed in the form of icons. If a new function is added to an image forming apparatus, an icon representing the new function is displayed on the menu screen, whereby the user can select a desired function. The menu screen is displayed if a dedicated call button is pressed or upon power-on of the image forming apparatus.

As users use more functions, the simple menu screen function is likely to lead to an issue that screens to be displayed increase and the users have difficulty in finding a desired function. To solve such an issue, Japanese Patent Application Laid-Open No. 2017-001368 discusses an example of displaying histories of activated operations in a usable manner user by user.

### SUMMARY

According to embodiments of the present disclosure, an image forming apparatus configured to form an image includes a generation unit configured to generate a document image based on a job setting when a function is executed and a job result when the function is executed, and a display unit configured to display the job setting and the document image as a history of the function.

Further features of the present disclosure will become apparent from the following description of exemplary embodiments with reference to the attached drawings.

### BRIEF DESCRIPTION OF THE DRAWINGS

FIG. 1 is a diagram illustrating an example of a hardware configuration of an image forming apparatus.

FIG. 2 is a diagram illustrating an example of a software configuration of the image forming apparatus.

FIGS. 3A to 3K are diagrams illustrating examples of a main screen.

FIGS. 4A to 4E are charts illustrating examples of a job information table.

FIGS. 5A to 5E are charts illustrating examples of history information.

FIG. 6 is a flowchart illustrating an example of information processing for issuing a history registration request.

FIGS. 7A to 7E are flowcharts illustrating examples of history addition processing by a history control unit.

FIG. 8 is a flowchart illustrating information processing for re-executing a function based on a history.

FIG. 9 is a flowchart illustrating information processing for generating an original image as a document image.

FIG. 10 is a flowchart illustrating information processing for generating a product image.

FIG. 11 is a flowchart illustrating original and product difference determination processing.

### DESCRIPTION OF THE EMBODIMENTS

Japanese Patent Application Laid-Open No. 2017-001368 discusses an information processing apparatus that displays function names or setting contents of functions (hereinafter, setting contents) in the form of menu items displayed as operation histories. The user can select a function to be re-executed by referring to the function names or the setting contents. In such a case, to select a function to be re-executed, the user needs to memorize the function name or the setting contents of the function in advance, and recall the function to be re-executed based on the function names or the setting contents displayed as histories. Some uses remember executed functions not by function name or setting contents but in terms of documents processed when the functions are executed. Such users may have difficulty in recalling and selecting the function to be re-executed even if the function name or the setting contents are displayed as a history.

According to an exemplary embodiment of the present disclosure, a history display that facilitates selecting a function to be re-executed can be provided.

Exemplary embodiments of the present disclosure will be described below with reference to the drawings.

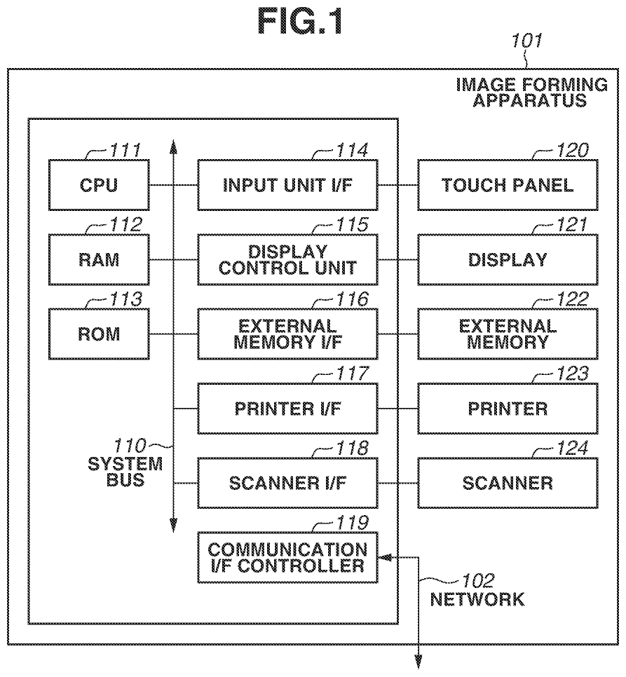

A first exemplary embodiment will be described. FIG. 1 is a diagram illustrating an example of a hardware configuration of an image forming apparatus 101. A central processing unit (CPU) 111, a random access memory (RAM) 112, a read-only memory (ROM) 113, an input unit 114, a display control unit 115, an external memory interface (I/F) 116, a printer I/F 117, a scanner I/F 118, and a communication I/F controller 119 are connected to a system bus 110. A touch panel 120, a display 121, an external memory 122, a printer 123, and a scanner 124 are also connected to the system bus 110 via the input unit 114, the display control unit 115, the external memory I/F 116, the printer I/F 117, and the scanner I/F 118, respectively. The components connected to the system bus 110 are configured to be able to exchange data with each other via the system bus 110. The ROM 113 is a nonvolatile memory. Image data, other data, and various programs for operating the CPU 111 are stored in respective predetermined areas of the ROM 113. The RAM 112 is a volatile memory, and used as temporary storage areas, such as a main memory and a work area of the CPU 111. For example, the CPU 111 controls the components of the image forming apparatus 101 based on the programs stored in the ROM 113, using the RAM 112 as a work memory. The storage location of the programs for operating the CPU 111 is not limited to the ROM 113, and the programs may be stored in the external memory (such as a hard disk) 122 in advance.

The input unit 114 accepts user operations, generates control signals based on the user operations, and supplies the control signals to the CPU 111. For example, the input unit 114 is connected to the touch panel 120 serving as an input device for accepting user operations. For example, the touch panel 120 is an input device configured to output coordinate information based on a touch position on an input member of flat configuration. The CPU 111 controls the components of the image forming apparatus 101 based on the programs and based on the control signals generated and supplied from the input unit 114 in response to user operations made on the input device. The image forming apparatus 101 can thus make operations corresponding to the user operations. The display control unit 115 outputs a display signal for displaying an image on the display 121. For example, the CPU 111 generates a display control signal based on a program, and supplies the display control signal to the display control unit 115. The display control unit 115 generates the display signal based on the display control signal, and outputs the display signal to the display 121. For example, the display control unit 115 displays a graphical user interface (GUI) screen for constituting a GUI based on the display control signal generated by the CPU 111 on the display 121. The touch panel 120 is integrated with the display 121. For example, the touch panel 120 is configured to have a light transmittance so as not to interfere with display on the display 121, and attached onto the display surface of the display 121. Input coordinates on the touch panel 120 are associated with display coordinates on the display 121, whereby a GUI that enables the user to feel as if he/she is directly operating the screen displayed on the display 121 can be configured.

The external memory 122, such as a hard disk, a compact disc (CD), a digital versatile disc (DVD), and a memory card, can be mounted on the external memory/F 116. The external memory I/F 116 reads data from the mounted external memory 122 and writes data to the external memory 122 under the control of the CPU 111. The printer 123 is connected to the printer I/F 117. Image data to be printed by the printer 123 is transferred to the printer 123 via the printer I/F 117 under the control of the CPU 111. The printer 123 prints and outputs the image data on a recording medium. The scanner 124 is connected to the scanner I/F 118. The scanner 124 reads an image on an original and generates image data under the control of the CPU 111. The generated image data is stored into the RAM 112 via the scanner I/F 118. The communication I/F controller 119 communicates with various networks 102, such as a local area network (LAN) and the Internet, whether wired or wireless, under the control of the CPU 111. For example, the image data generated by the scanner 124 can be transmitted outside via the network 102. Image data received from outside via the network 102 can be printed by the printer 123. The CPU 111 can detect operations on and states of the touch panel 120. Any of various types of touch panels including a resistive, capacitive, surface acoustic wave, infrared, electromagnetic induction, image recognition, and optical sensor touch panels may be used as the touch panel 120. The image forming apparatus 101 according to the first exemplary embodiment thus has a plurality of functions including a print function, a scan function, and a copy function.

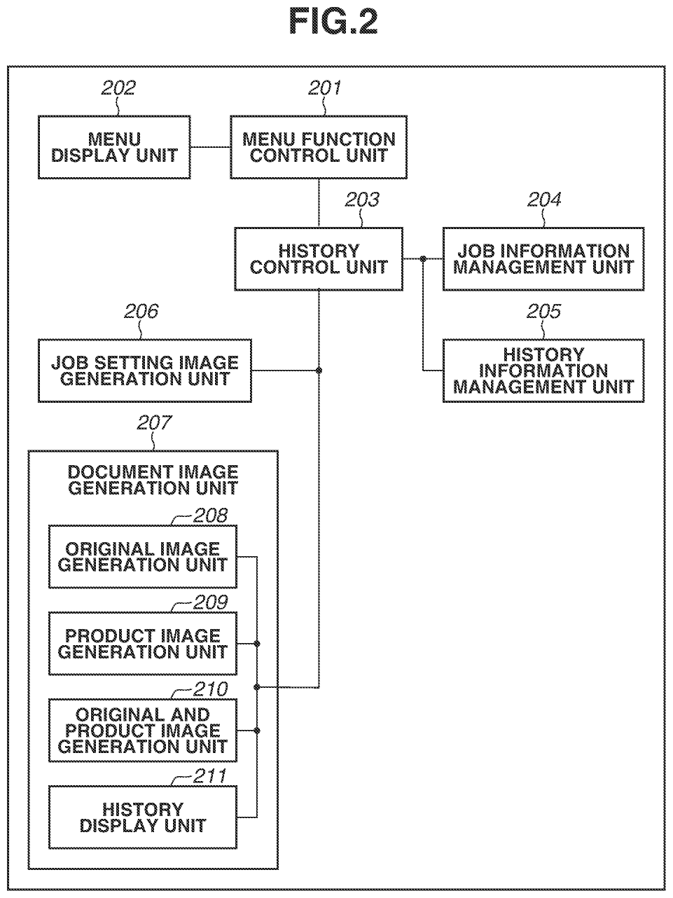

FIG. 2 is a diagram illustrating an example of a software configuration of the image forming apparatus 101. Software modules in the image forming apparatus 101 illustrated in FIG. 2 are implemented by the CPU 111 reading control programs stored in the ROM 113 or the external memory 122 and executing the control programs. The image forming apparatus 101 includes the following software modules: a menu function control unit 201, a menu display unit 202, a history control unit 203, a job information management unit 204, a history information management unit 205, a job setting image generation unit 206, and a document image generation unit 207. The image forming apparatus 101 also includes an original image generation unit 208, a product image generation unit 209, an original and product image generation unit 210, and a history display unit 211 in the document image generation unit 207.

An original refers to an original paper document or image data that is input in executing the scan, print, or copy function of the image forming apparatus 101. A product refers to a paper document or image data that is output as an execution result of the function. A job execution result refers to the result of the execution of a job corresponding to each function of the image forming apparatus 101. The job execution result includes image data input or output during job execution, job settings during job execution, and a job result indicating an execution state of the job. A history refers to a record of execution of each function of the image forming apparatus 101. The display 121 displays history buttons representing histories on the display 121 for user presentation. If a history button displayed on the display 121 is selected by the user on the touch panel 120, the function can be re-executed with the same job settings as when the history is recorded. A job setting image refers to an image indicating the job settings of a job executed when a history is recorded. An original image refers to an image representing the original used in a job executed when a history is recorded. A product image refers to an image indicating the product resulting from a job executed when a history is recorded. Unlike an original, an original image is an image schematically indicating the appearance or contents of the original paper document. Unlike a product, a product image is an image schematically illustrating the appearance or contents of the product paper document. An original and product image refers to an image indicating the original and product of a job executed when a history is recorded. Original, product, and original and product images will be referred to collectively as document images. In the following description, a document image thus refers to an image indicating a document used in a job executed when a history is recorded.

The menu function control unit 201 generates a menu screen. More specifically, the menu function control unit 201 generates data on the menu screen to be displayed on the display 121 in the RAM 112, and switches a screen to a function selected by the user on the menu screen. The menu function control unit 201 is used for executing scan, print, and copy jobs that are functions of the menu display unit 202. The menu function control unit 201 transmits job information about executed jobs, pre-processing images, and post-processing images to the history control unit 203, and requests history addition processing from the history control unit 203. Details of the processing of the menu function control unit 201 will be described below.

The menu display unit 202 controls the display control unit 115 to display the data generated by the menu function control unit 201 on the display 121.

The history control unit 203 displays history buttons on a history screen by using the job information received from the menu function control unit 201. The history control unit 203 requests the job information management unit 204 to store the job information, the pre-processing images, and the post-processing images received from the menu function control unit 201, and requests the history information management unit 205 to store history information indicating history buttons. The history control unit 203 then generates a history screen including history buttons based on the history information stored in the history information management unit 205. The history screen displays functions used by the user among a plurality of functions of the image forming apparatus 101 as the user's use histories. If the user selects a history, the function is executed with the same job settings as when the history is recorded. More specifically, the history control unit 203 generates data about the history screen to be displayed on the display 121 in the RAM 112, and switches the screen to the function selected by the user on the history screen. The history control unit 203 requests the job setting image generation unit 206 to generate a job setting image from the job information stored in the job information management unit 204. The history control unit 203 requests the original image generation unit 208 of the document image generation unit 207 to generate an original image from the job information stored in the job information management unit 204. The history control unit 203 requests the product image generation unit 209 of the document image generation unit 207 to generate a product image from the job information stored in the job information management unit 204. The history control unit 203 requests the original and product image generation unit 210 of the document image generation unit 207 to generate an original and product image from the job information stored in the job information management unit 204 or from the history information management unit 205. The history control unit 203 then requests the history information management unit 205 to store the generated job setting image, original image, product image, and original and product image. The history control unit 203 also has a function of detecting that a history button displayed on the history screen is selected by the user, obtaining history information corresponding to the selected history button from the history information management unit 205, and re-executing the job executed when the history is recorded. Details of the processing will be described below.

The history display unit 211 controls the display control unit 115 to display the data generated by the history control unit 203 on the display 121.

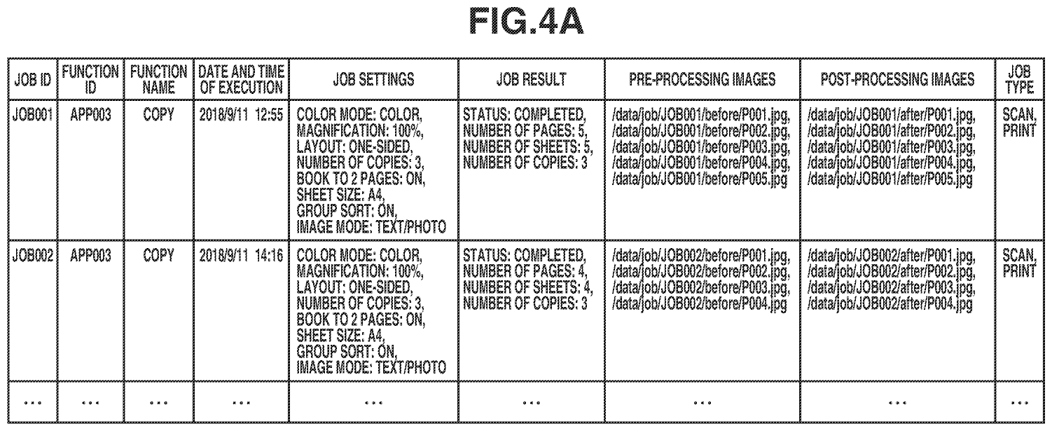

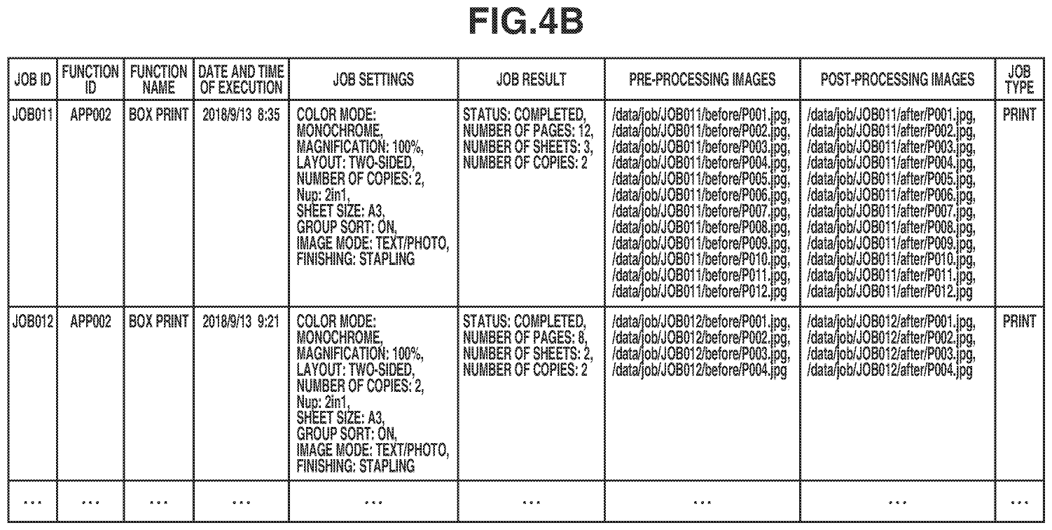

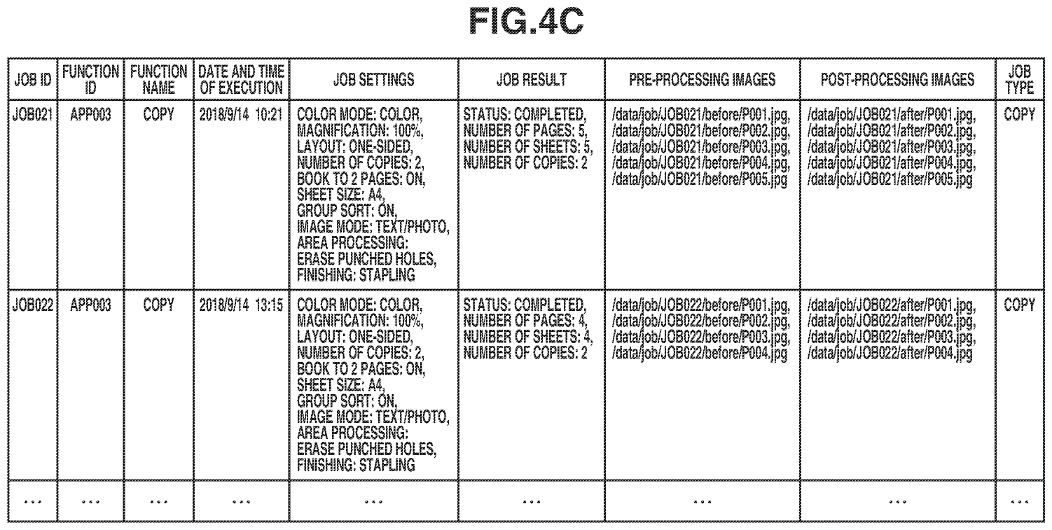

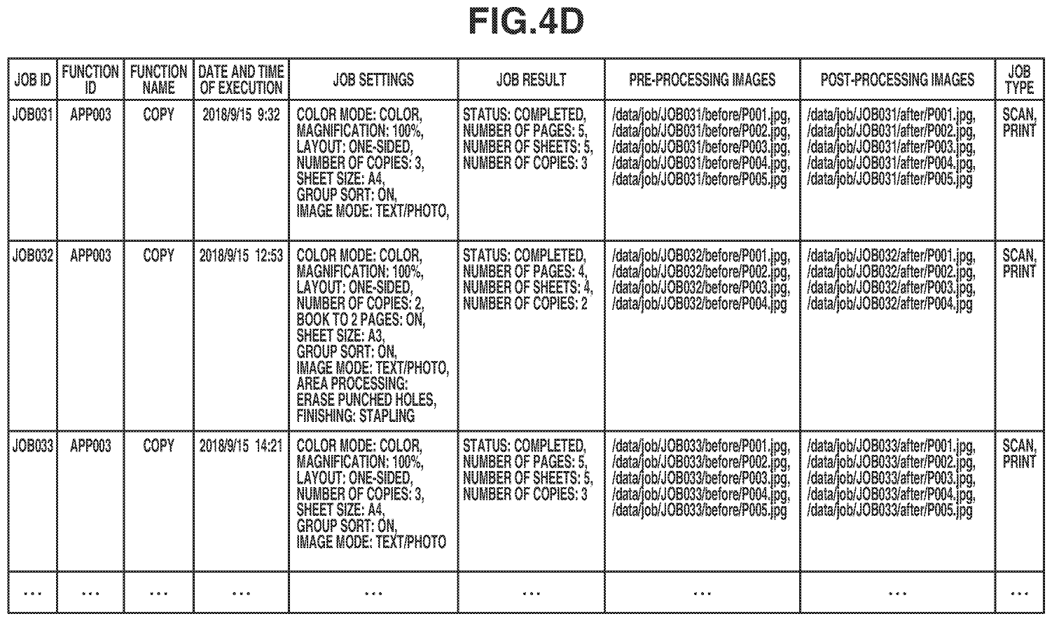

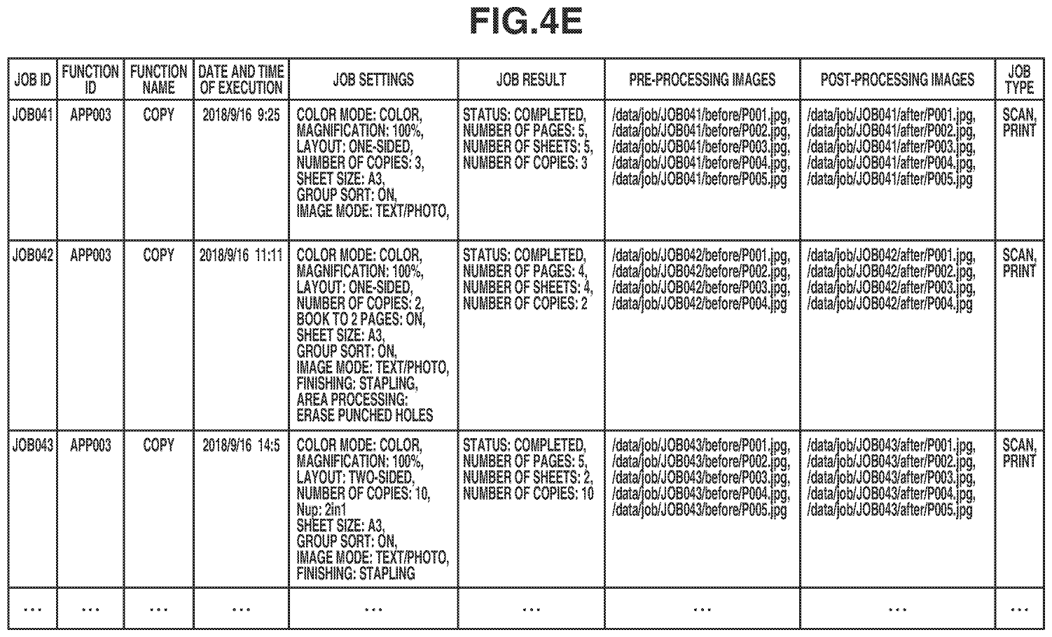

The job information management unit 204 manages a job information table illustrated in FIGS. 4A to 4E (described below). The job information managed by the job information table is stored in the external memory 122. The job information management unit 204 reads job information from the external memory 122 and writes job information to the external memory 122 based on requests from the history control unit 203. The job information management unit 204 also stores the pre-processing images and post-processing images received from the history control unit 203 into the external memory 122, and stores the paths of the images into the job information table illustrated in FIGS. 4A to 4E (described below).

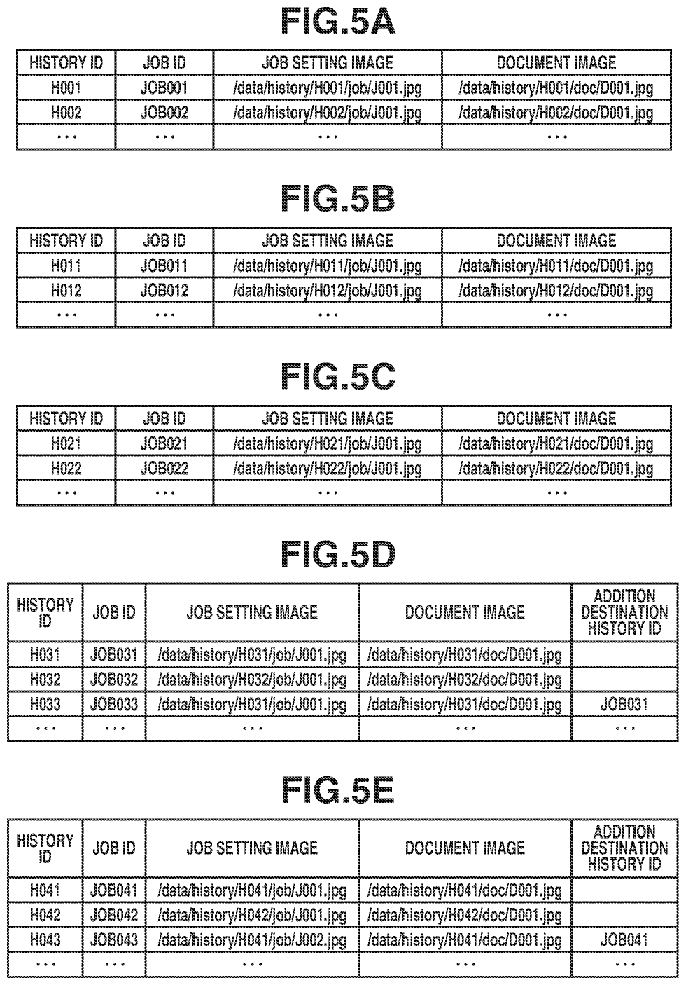

The history information management unit 205 manages information, obtained from the history control unit 203, about the histories of jobs executed by the menu function control unit 201. The history information management unit 205 manages a history information table illustrated in FIGS. 5A to 5E (described below). The history information managed by the history information table is stored in the external memory 122. The history information management unit 205 reads history information from the external memory 122 and writes history information to the external memory 122 based on requests from the history control unit 203. The history information management unit 205 also stores job setting images and document images received from the history control unit 203 into the external memory 122, and stores the paths of the images into the history information table illustrated in FIGS. 5A to 5E (described below).

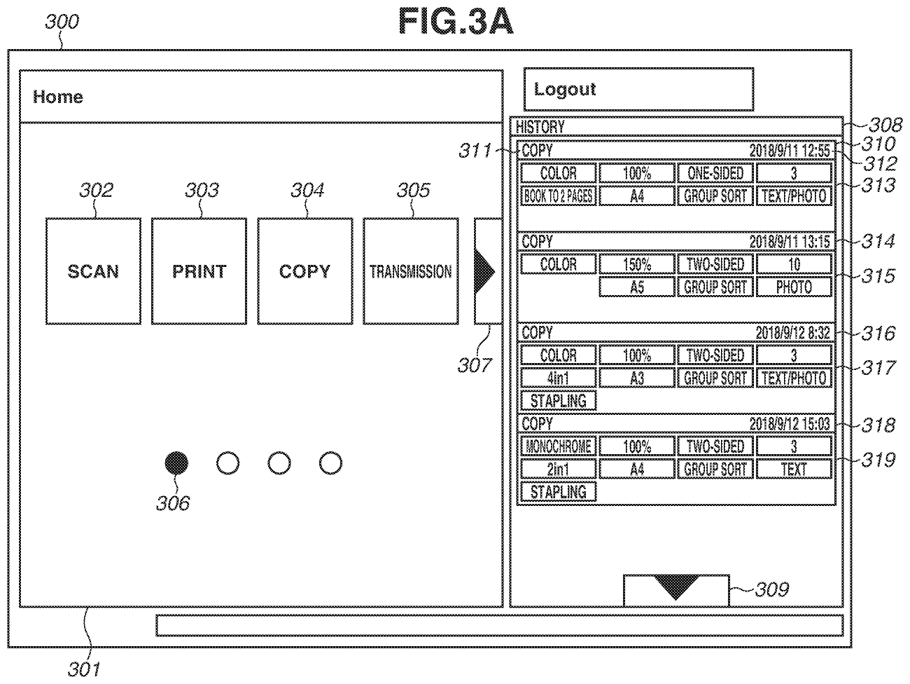

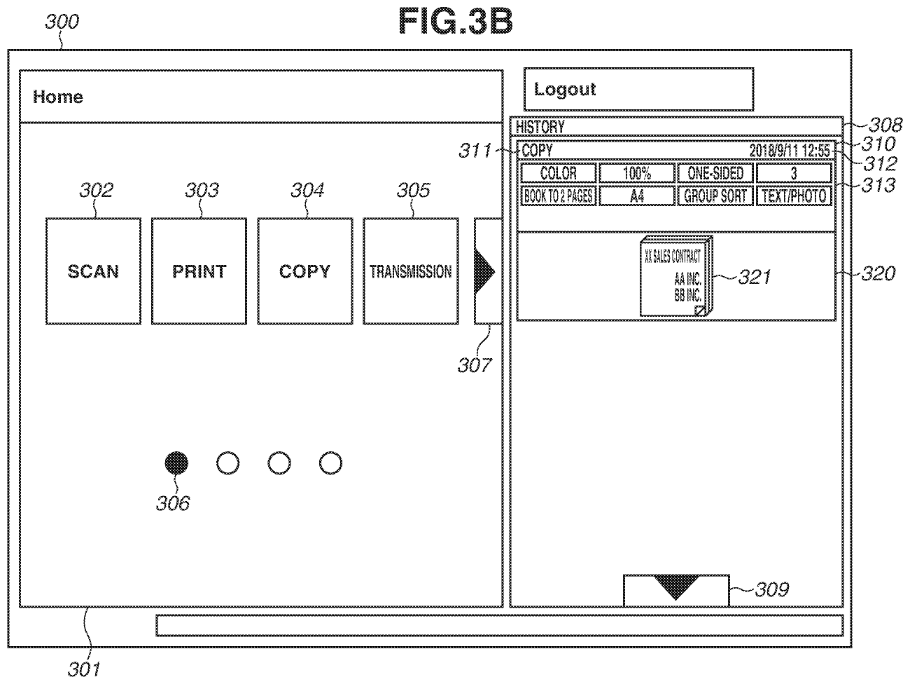

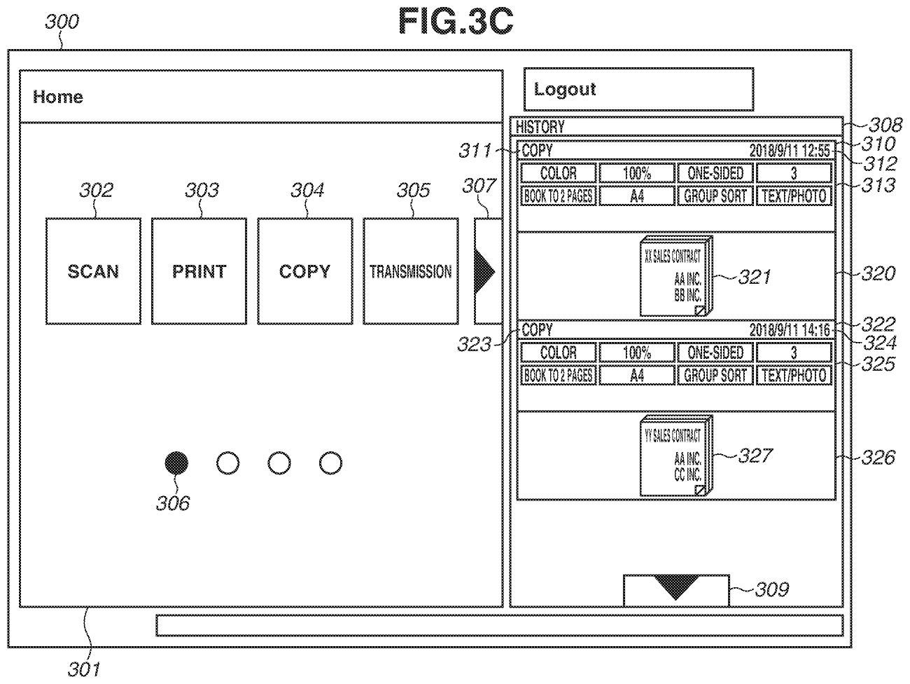

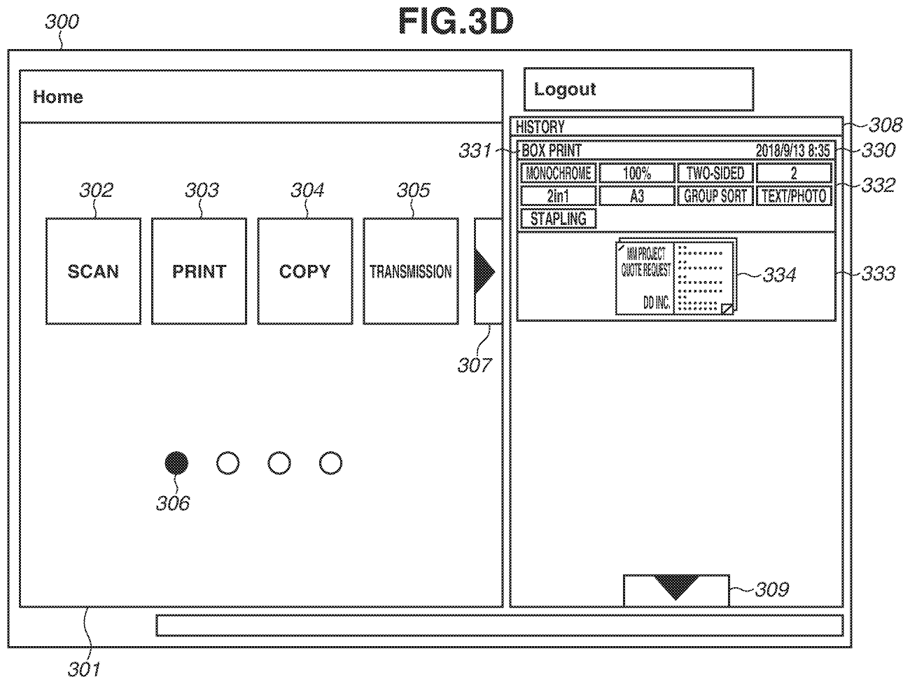

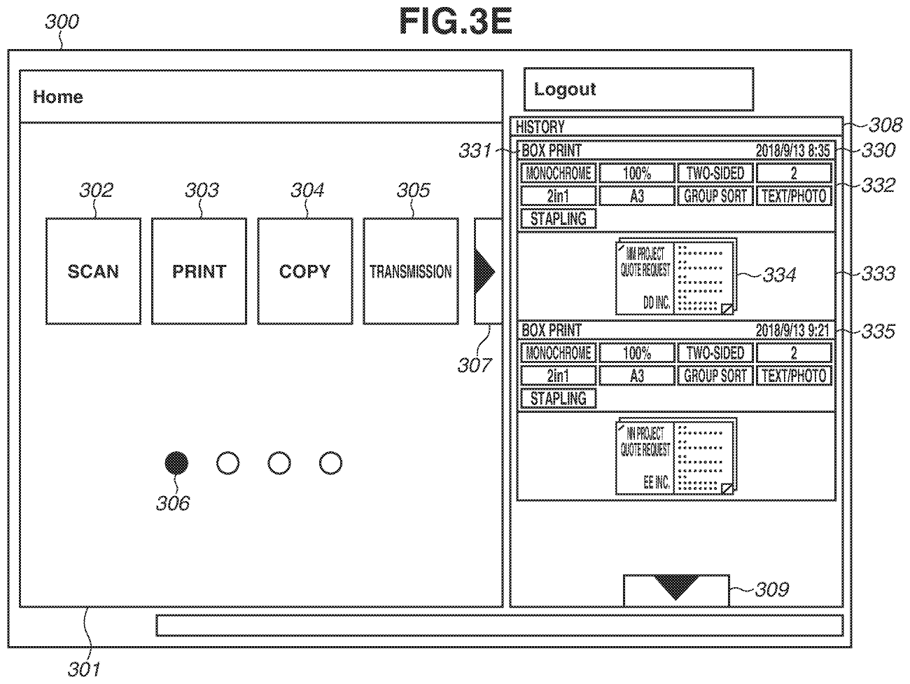

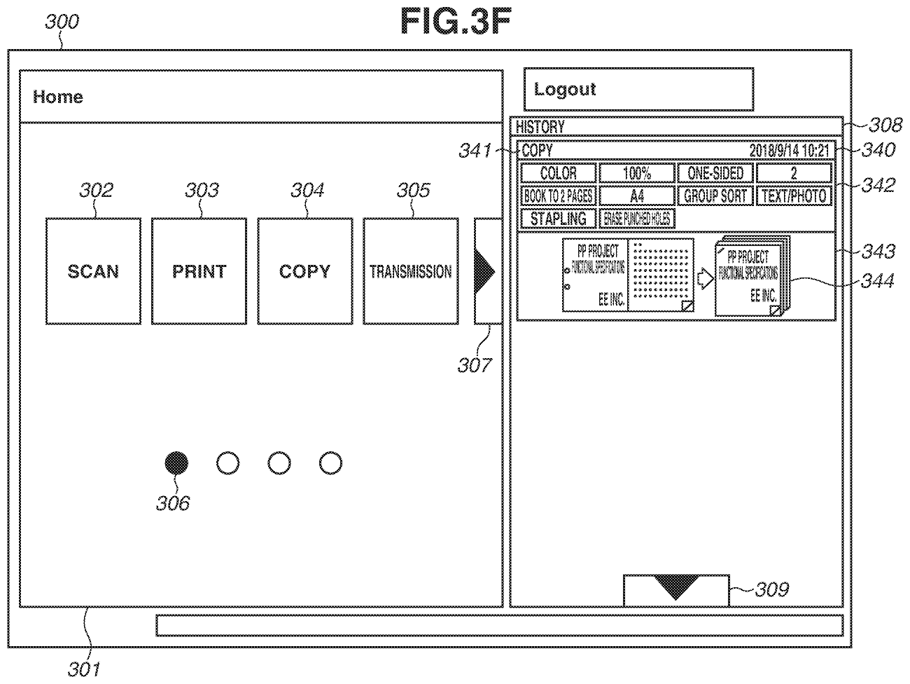

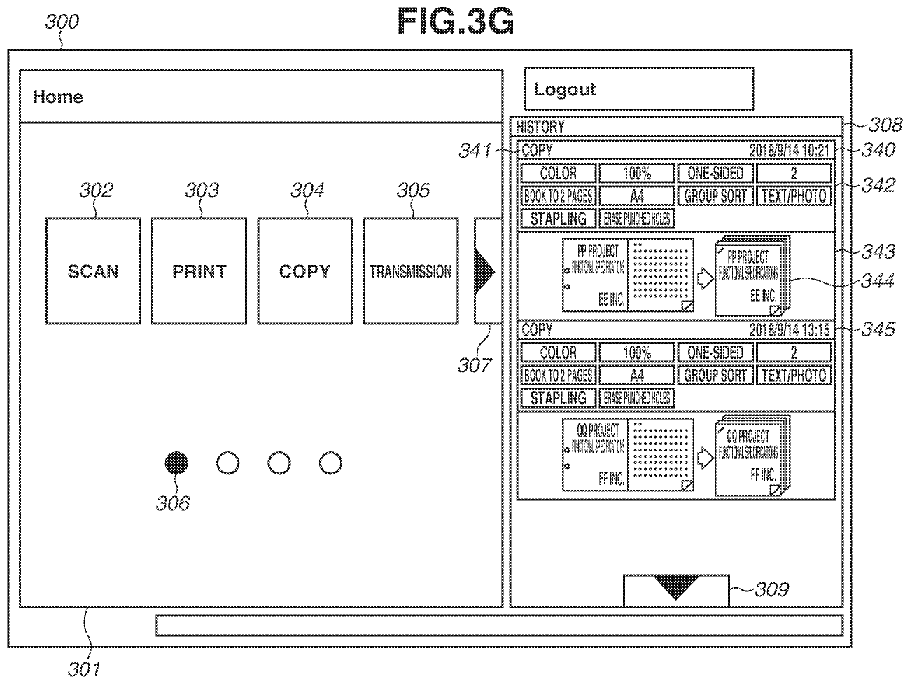

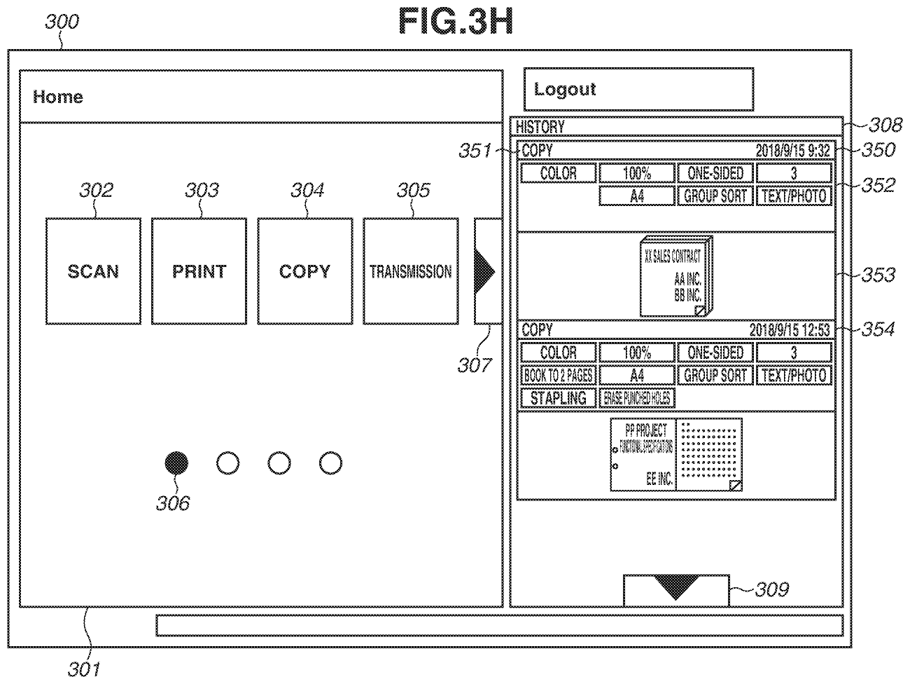

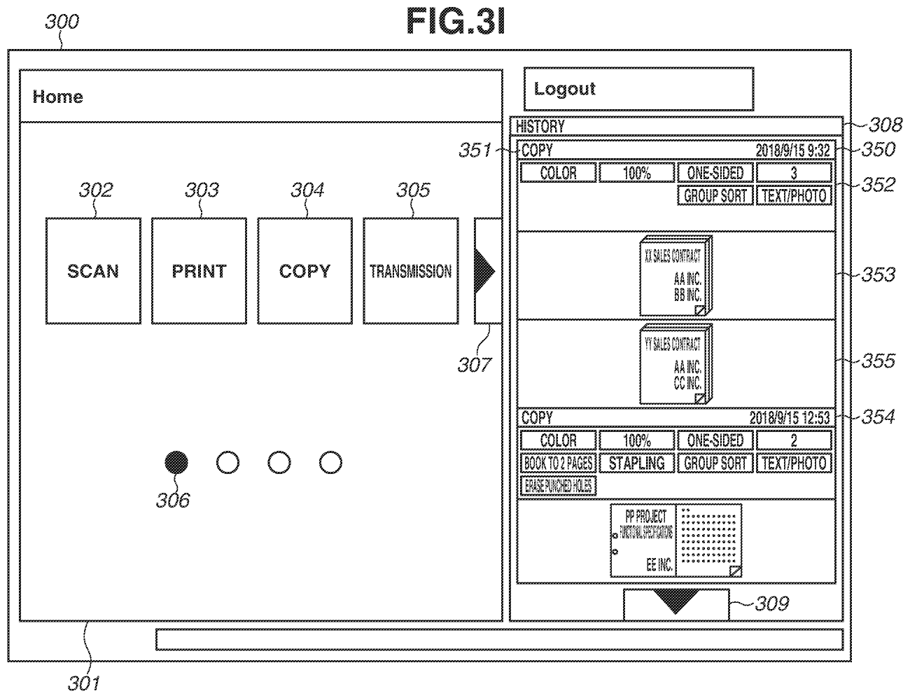

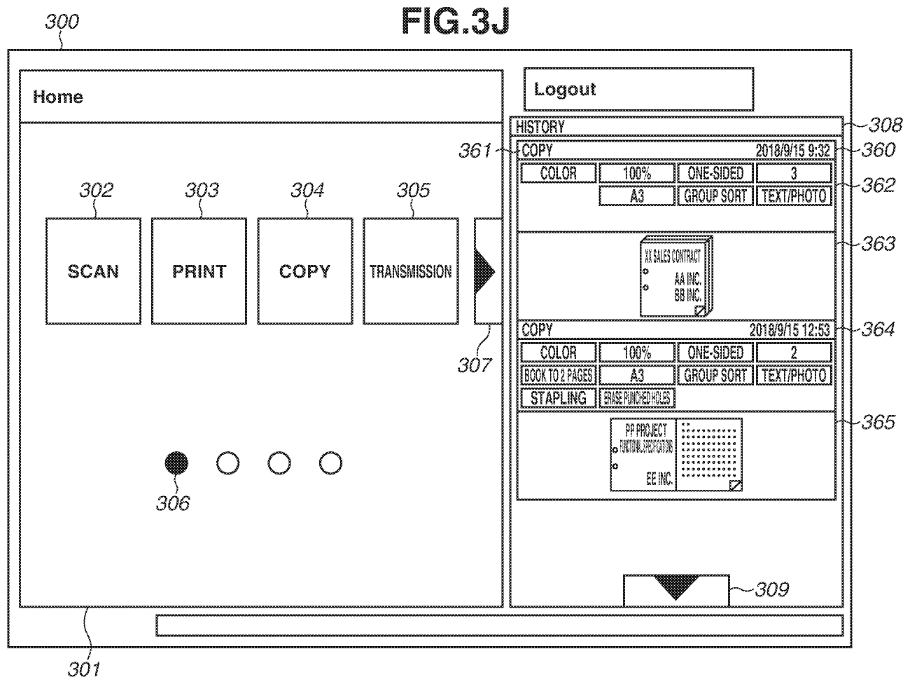

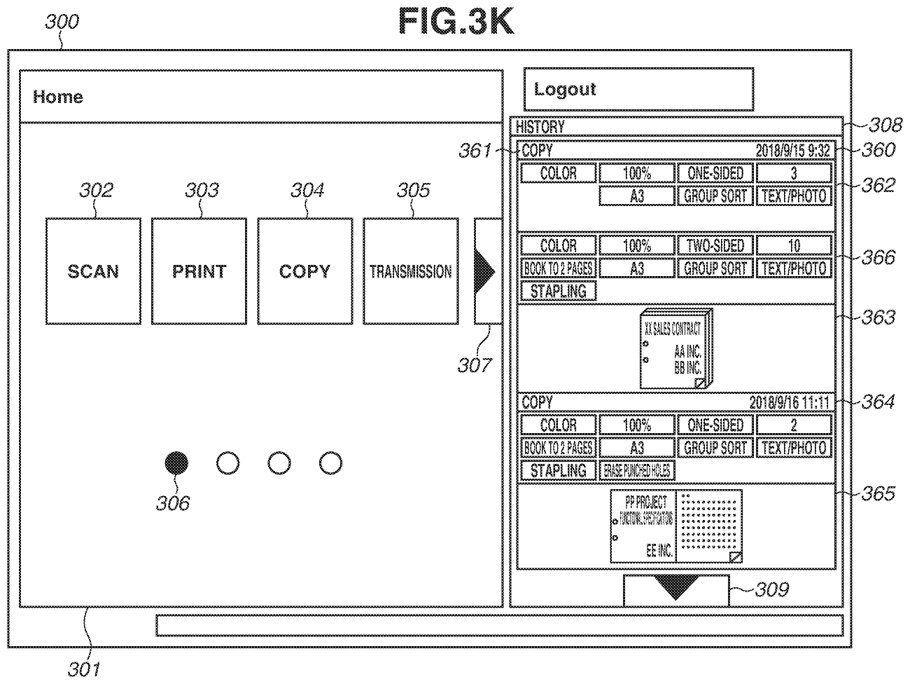

FIGS. 3A to 3K are diagrams illustrating examples of a main screen 300 that is displayed on the display 121 of the image forming apparatus 101 and displays function buttons and history buttons. FIG. 3A illustrates an example of the main screen 300 in a case where the present exemplary embodiment is not applied. The main screen 300 includes a menu display region 301 and a history display region 308. Descriptions of buttons and display items not related to the present exemplary embodiment will be omitted. The menu display unit 202 displays the menu screen generated by the menu function control unit 201 in the menu display region 301 on the display 121. Function buttons 302, 303, 304, and 305 are function buttons for selecting and using “scan”, “print”, “copy”, and “transmission” functions, respectively. Page state buttons 306 indicate the state of the page displayed in the menu display region 301. The page state buttons 306 here indicate that the first page of four pages is currently displayed. A page transition button 307 is used for shifting the menu display region 301 to the next page. Instead of using the page transition button 307 that is a GUI button, the menu display region 301 may be scrolled. The history display region 308 is generated by the history control unit 203 and displayed on the display 121 by the history display unit 211. A history page transition button 309 is used for shifting the history display region 308 to the next page. Instead of using the history page transition button 309 that is a GUI button, the history display region 308 may be scrolled.

A history button 310 is a history button that displays a history of use of the “copy” function in the past and is intended to re-execute the “copy” function with the same job settings as in the past based on the history. A history function display 311 indicates the function name of the executed function, included in the history information. A history time display 312 indicates the time of execution, included in the history information. A job setting image (history job setting display) 313 indicates the contents of the job settings of the executed job, included in the history information.

A history button 314 is one that displays a history of use of the “copy” function in the past and is intended to re-execute the “copy” function with the same job settings as in the past based on the history. A history job setting display 315 indicates the contents of the job settings during execution, included in the history information.

A history button 316 is one that displays a history of use of the “copy” function in the past and is intended to re-execute the “copy” function with the same job settings as in the past based on the history. A history job setting display 317 indicates the contents of the job settings during execution, included in the history information.

A history button 318 is one that displays a history of use of the “copy” function in the past and is intended to re-execute the “copy” function with the same job settings as in the past based on the history. A history job setting display 319 indicates the contents of the job settings during execution, included in the history information.

The history buttons 310, 314, 316, and 318 represent the histories of execution of the same “copy” function, whereas the contents of the respective history job setting displays are different. If the user remembers the contents of the job settings during execution in the past, the user can recall the contents of the job settings for the function he/she wants to re-execute and select the history button for re-execution based on the contents of the history job setting displays. However, if the user remembers not the contents of the job settings during execution in the past but the document, there is an issue that the user has difficulty in recalling the job he/she wants to re-execute and selecting the history button for re-execution even by observing the contents of the history job setting displays. In particular, selecting the history button for re-execution can be difficult if a lot of history buttons about the same function are displayed as illustrated in FIG. 3A.

FIG. 3B illustrates an example of the main screen 300 before job execution according to the present exemplary embodiment. Descriptions of buttons and display items not related to the present exemplary embodiment will be omitted. In the present exemplary embodiment, display contents designated by the same reference numerals as in FIG. 3A are similar to those in FIG. 3A unless otherwise specified. A difference from FIG. 3A is that the history button 310 includes a history document display 320 and a history original image 321 in addition to the history function display 311, the history time display 312, and the job setting image 313. In FIG. 3B, the main screen 300 displays a single history button as a state before job execution. The history document display 320 displays an image of a document used in the job executed when the history button 310 is registered. In the present exemplary embodiment, as the image of the document used in the job, the history document display 320 displays the history original image 321 schematically representing an original used as a job input. The history original image 321 is an image schematically representing the original used as the input of the job executed when the history button 310 is registered. The history original image 321 schematically represents a front cover of the original and a thickness image indicating the number of sheets of the original scanned when the “copy” function is executed. The history original image 321 does not need to be an image that faithfully represents the original. For example, the thickness of the original may be displayed not by the thickness image but by a numeral indicating the number of sheets or pages of the original. The same applies to the following description.

FIG. 3C illustrates an example of the main screen 300 after job execution according to the present exemplary embodiment. Descriptions of buttons and display items not related to the present exemplary embodiment will be omitted. In FIG. 3C, display contents designated by the same reference numerals as in FIGS. 3A and 3B are similar to those in FIGS. 3A and 3B unless otherwise specified. A difference from FIG. 3B is that a history button 322 is displayed in addition to the history button 310. In other words, in FIG. 3C, the main screen 300 displays one additional history button, i.e., two history buttons, as a state after job execution. The history button 322 includes a history function display 323, a history time display 324, a history job setting display 325, a history document display 326, and a history original image 327.

The history button 322 is one that displays a history of execution of a job of the “copy” function and is intended to re-execute the “copy” function with the same job settings as in the past based on the history. The history function display 323 indicates the function name of the executed function, included in the history information. The history time display 324 indicates the time of execution, included in the history information. The history job setting display 325 indicates the contents of the job settings of the executed job, included in the history information. The history document display 326 displays the image of the document used in the job executed when the history button 322 is registered. In the present exemplary embodiment, as the image of the document used in the job, the history document display 326 displays the history original image 327 schematically representing the original used as a job input. The history original image 327 is an image schematically representing the original used as the input of the job executed when the history button 322 is registered. The history original image 327 schematically represents the front cover of the original and a thickness image indicating the number of sheets of the original scanned when the “copy” function is executed.

FIGS. 4A to 4E are charts illustrating examples of the job information table. The job information table includes job information about job execution that the menu function control unit 201 transmits to the history control unit 203 after a job of a function is executed. While FIGS. 4A to 4E illustrate the job information table in a database format, the job information table may be in a file format such as a comma separated value (CSV) format and an Extensible Markup Language (XML) format. The job information table includes a job identifier (ID) of an executed job, a function ID, a function name, and a date and time of execution. The job information table also includes job settings when a function is executed as a job, a job result indicating a state of the job, the paths of pre-processing images representing the images of respective pages of a document before job execution, and the paths of post-processing images representing the images of respective pages of the document after job execution. While the pre- and post-processing image fields of the job information table illustrated in FIGS. 4A to 4E include the paths of the pre- and post-processing images stored in the external memory 122, the binary data of the image files may be stored instead. The job information table further includes a job type indicating the type of job. The first exemplary embodiment will be described with reference to FIG. 4A.

FIGS. 5A to 5E are charts illustrating examples of the history information table. The history information table includes information about histories of acceptance of history registration requests by the history control unit 203 when jobs are executed by the menu function control unit 201. While FIGS. 5A to 5E illustrate the history information table in a database format, the history information table may be in a file format such as a CSV format and an XML format. The history information table includes a history ID uniquely identifying a history, and a job ID when the history is recorded. The history information table also includes the path of a job setting image and the path of a document image. While the job setting image field and the document image field of the history information table illustrated in FIGS. 5A to 5E include the paths of the job setting images and document images stored in the external memory 122, the binary data on the images may be directly stored instead. The first exemplary embodiment will be described with reference to FIG. 5A.

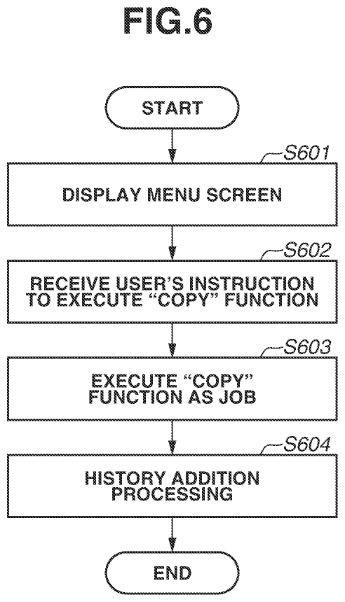

Next, an operation of the image forming apparatus 101 according to the first exemplary embodiment will be described with reference to FIG. 6. FIG. 6 is a flowchart illustrating an example of information processing of the image forming apparatus 101, where the “copy” function corresponding to the function button 304 displayed in the menu display region 301 of the main screen 300 on the screen of FIG. 3B is executed as a job and a history registration request is issued. The steps of FIG. 6 are processed by the CPU 111 executing a program stored in the ROM 113 or the external memory 122.

In step S601, the menu function control unit 201 detects that the “copy” function corresponding to the function button 304 is selected in the menu display region 301 of the main screen 300. The menu function control unit 201 requests the menu display unit 202 to display a menu screen for executing the “copy” function corresponding to the function button 304 in the menu display region 301. The menu display unit 202 displays the menu screen on the display 121.

In step S602, the menu function control unit 201 receives the user's instruction issued on the menu screen to execute the “copy” function via the menu display unit 202, and obtains the job settings input on the menu screen.

In step S603, the menu function control unit 201 executes the “copy” function as a job with the job settings obtained in step S602 (job execution processing).

In step S604, the menu function control unit 201 transmits job information, pre-processing images, and post-processing images obtained as a result of the execution of the job in step S603 to the history control unit 203, and requests the history addition processing from the history control unit 203 (issues a history addition processing request). The information processing ends.

In FIG. 6, the history addition processing is requested in step S604 after the job execution processing of step S603 ends. However, the processing of step S604 may be asynchronously performed before the job execution processing of step S603 ends.

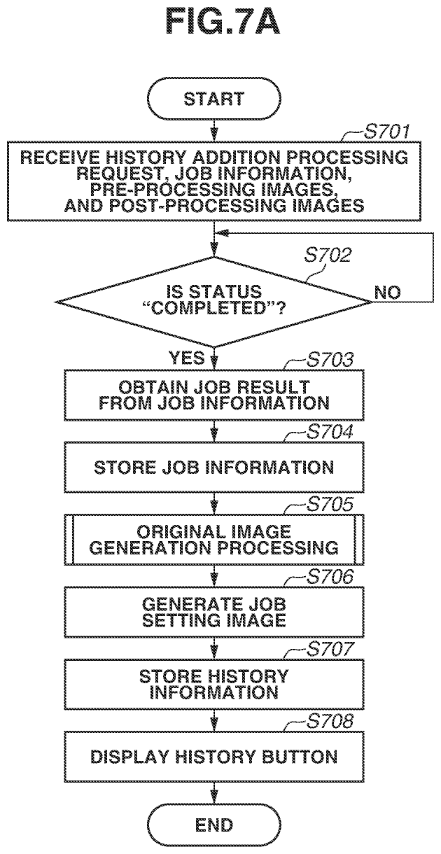

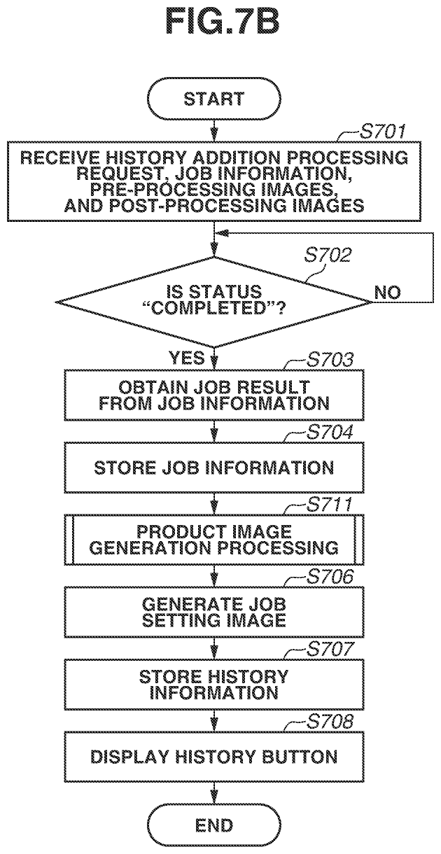

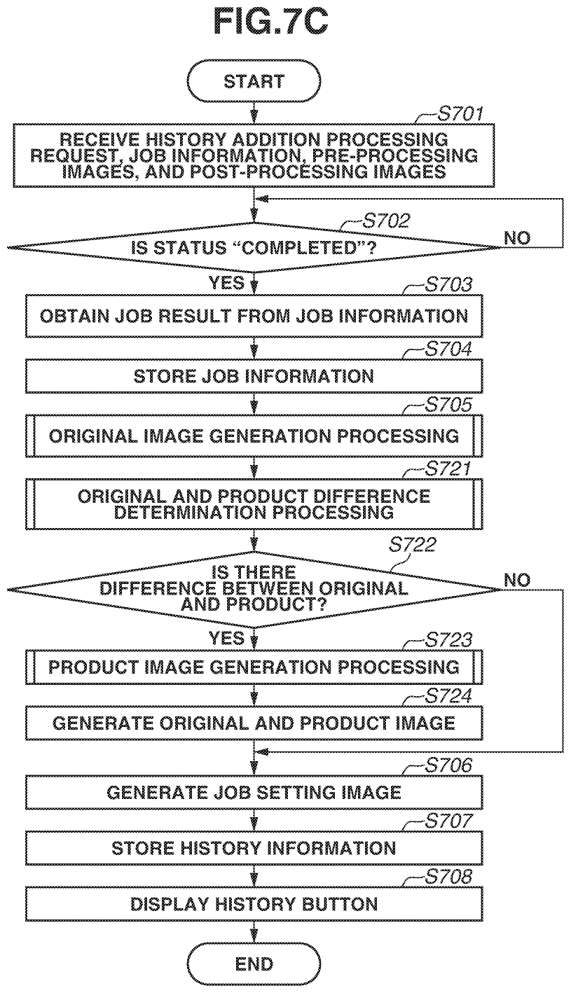

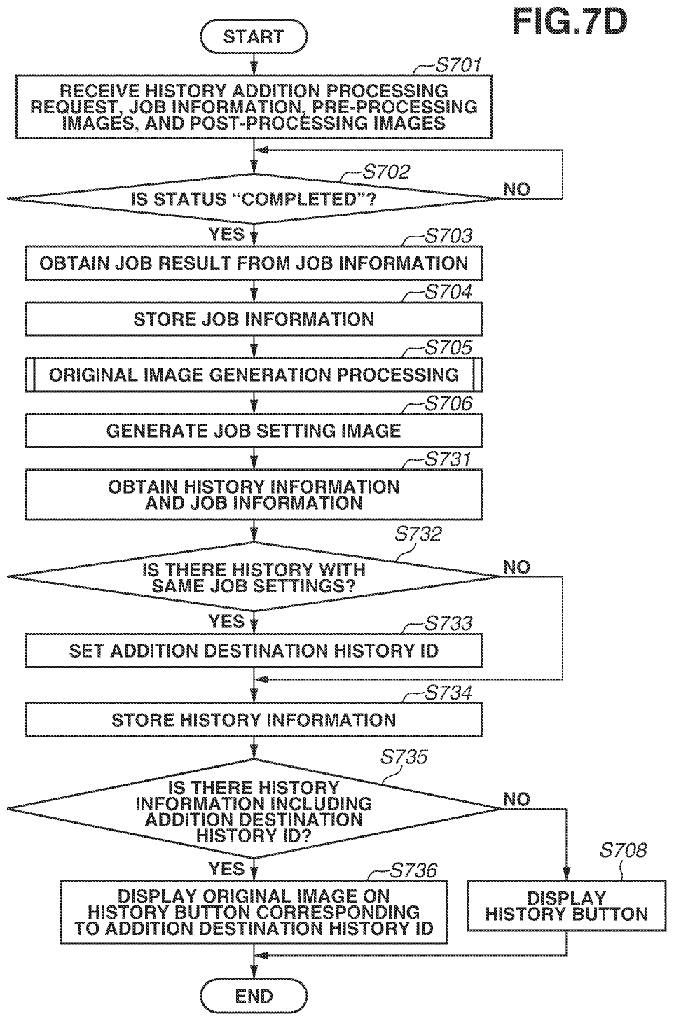

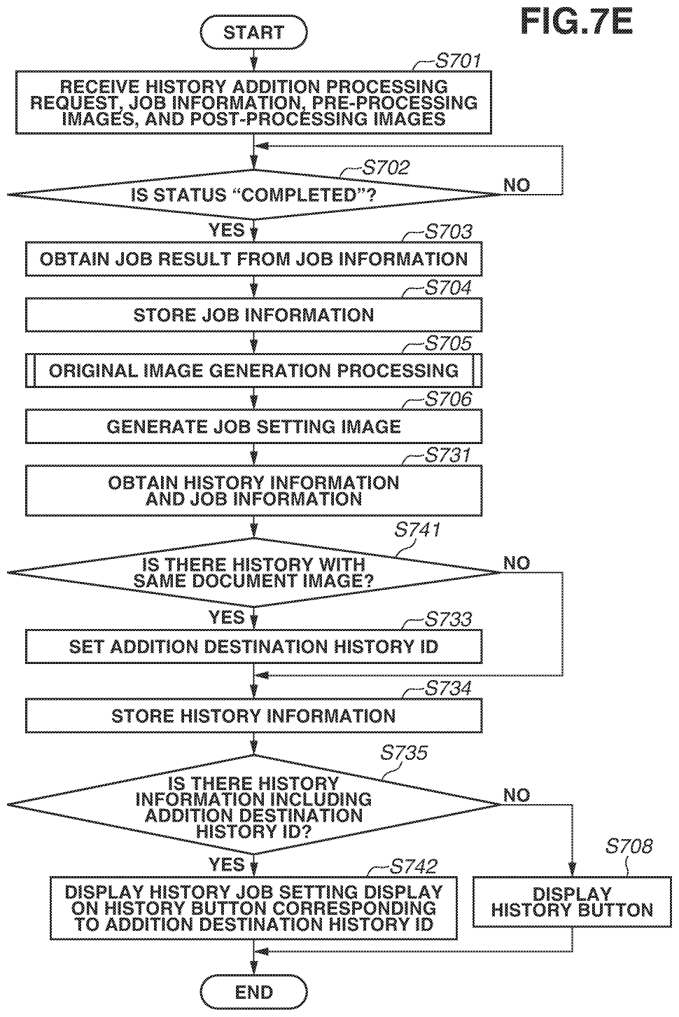

Next, an operation of the image forming apparatus 101 according to the first exemplary embodiment will be described with reference to FIG. 7A. FIG. 7A is a flowchart illustrating information processing of the image forming apparatus 101 according to the first exemplary embodiment, where the history control unit 203 performs the history addition processing when the history addition processing request from the menu function control unit 201 is received. The steps of FIG. 7A are processed by the CPU 111 executing a program stored in the ROM 113 or the external memory 122.

In step S701, the history control unit 203 receives the job information, the pre-processing images, the post-processing images, and the history addition processing request transmitted from the menu function control unit 201 in step S604 of FIG. 6.

In step S702, the history control unit 203 obtains the job ID included in the job information received from the job information management unit 204 in step S701, and determines whether the status in the job result is “completed”. If the history control unit 203 determines that the status is “completed” (YES in step S702), the processing proceeds to step S703. If the history control unit 203 determines that the status is not “completed” (NO in step S702), the processing returns to step S702.

In step S703, the history control unit 203 obtains the job result from the job information received in step S701.

In step S704, the history control unit 203 transmits the job ID, the function ID, the function name, the date and time of execution, and the job settings to the job information management unit 204 based on the job information received in step S701, and requests the job information management unit 204 to store the job information. The history control unit 203 also transmits the job result obtained in step S703 and the pre- and post-processing images to the job information management unit 204, and requests the job information management unit 204 to store the job information. The job information management unit 204 stores the received pre- and post-processing images into the external memory 122, and obtains the paths of the pre- and post-processing images. The job information management unit 204 then stores the received job information and the paths of the pre- and post-processing images into the external memory 122. As a result, in the first exemplary embodiment, the job information having a job ID “JOB001” illustrated in FIG. 4A is stored.

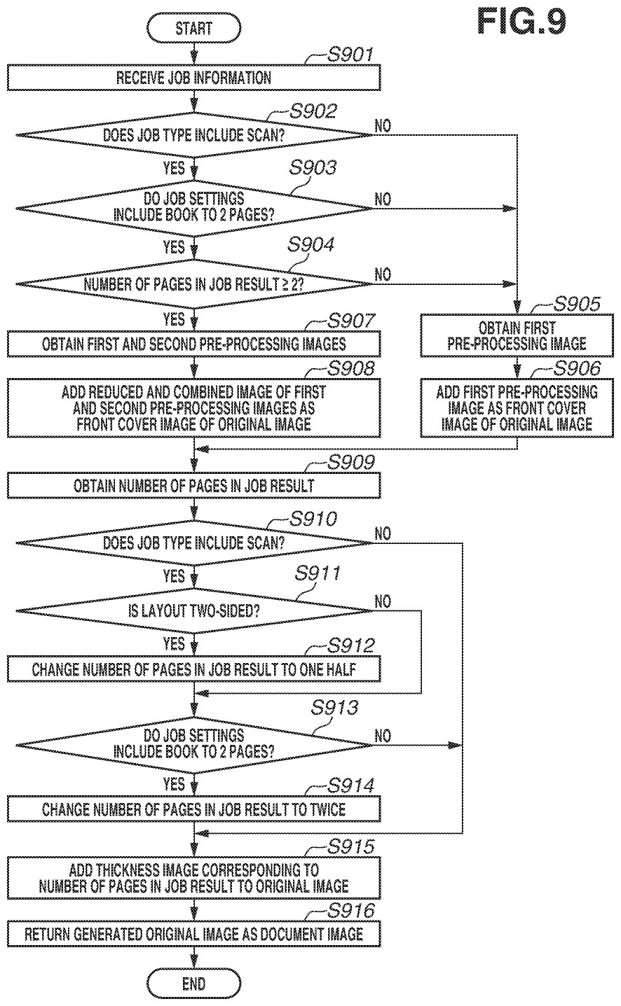

In step S705, the history control unit 203 transmits the job information to the original image generation unit 208 of the document image generation unit 207, requests the original image generation unit 208 to generate an original image, and obtains the original image from the original image generation unit 208. In the first exemplary embodiment, in the case of the job ID “JOB001” in FIG. 4A, the original image generation unit 208 generates an image such as the history original image 321 of FIG. 3B. Details of this processing will be described with reference to FIG. 9.

In step S706, the history control unit 203 transmits the job information to the job setting image generation unit 206 and requests the job setting image generation unit 206 to generate a job setting image. The job setting image generation unit 206 generates an image schematically indicating the contents of the job settings from the received job information. For example, in the case of the job ID “JOB001” in FIG. 4A, the job setting image generation unit 206 generates an image like the job setting image 313 in FIG. 3B. Specifically, the job setting image 313 in FIG. 3B schematically indicates a color mode “color”, a magnification “100%”, a layout “one-sided”, and the number of copies “3”. The job setting image 313 also schematically indicates a book to 2 page setting “ON”, a sheet size “A4”, group sort “ON”, and an image mode “text/photo”. The job setting image 313 of FIG. 3B expresses the job settings in the form of character strings, whereas icon images schematically representing the respective job settings may be used. The job setting image generation unit 206 transmits the generated job setting image to the history control unit 203. The history control unit 203 obtains the job setting image.

In step S707, the history control unit 203 transmits the job ID, the document image (original image), and the job setting image obtained in steps S702, S705, and S706 to the history information management unit 205, and requests the history information management unit 205 to store history information. The history information management unit 205 stores the received job setting image and document image into the external memory 122, and obtains the storage paths of the job setting image and the document image. The history information management unit 205 then stores the received job ID and the paths of the job setting image and the document image into the external memory 122. As a result, in the first exemplary embodiment, the history information having a history ID of “H001” illustrated in FIG. 5A is stored.

In step S708, the history control unit 203 requests the history display unit 211 to display the function name, the date and time of execution, the document image, and the job setting image obtained in step S704, S704, S705, and S706 as a history button in the history display region 308 of the main screen 300. The history display unit 211 displays the requested history button on the display 121. In such a manner, in the first exemplary embodiment, the history corresponding to the history ID “H001” of FIG. 5A is displayed on the history button 310 illustrated in FIG. 3B. The history addition processing ends.

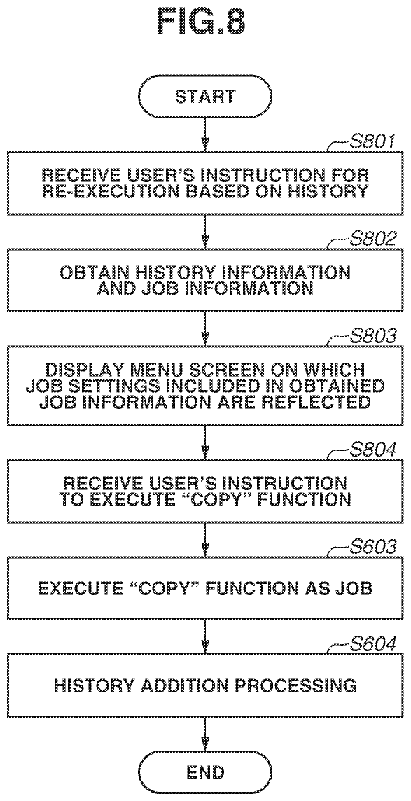

Next, an operation of the image forming apparatus 101 according to the first exemplary embodiment will be described with reference to FIG. 8. FIG. 8 is a flowchart illustrating information processing of the image forming apparatus 101 according to the first exemplary embodiment, where the history button 310 displayed in the history display region 308 of the main screen 300 is selected and the “copy” function is re-executed based on the history. After the processing illustrated in FIGS. 6 and 7A, the history button 310 is displayed in the history display region 308 of the main screen 300. If the history button 310 is selected by the user, the processing of FIG. 8 is performed to execute the “copy” function with the same job settings as when the history button 310 is registered. The steps of FIG. 8 are processed by the CPU 111 executing a program stored in the ROM 113 or the external memory 122. In FIG. 8, steps and processing designated by the same reference numerals as in FIG. 6 are similar to those in FIG. 6 unless otherwise specified.

In step S801, in the state where the history button 310 is displayed in the history display region 308 of the main screen 300 after the processing of FIGS. 6 and 7A, the history control unit 203 detects that the history button 310 is selected by the user. The history control unit 203 receives the instruction for re-execution based on the history of the history button 310, issued by the user in the history display region 308, via the history display unit 211.

In step S802, the history control unit 203 transmits the history ID of the history button 310 selected in step S801 to the history information management unit 205. The history information management unit 205 reads the history information corresponding to the history button 310 based on the history ID, and transmits the read history information to the history control unit 203. Here, the history information having the history ID “H001” illustrated in FIG. 5A is obtained as the history information corresponding to the history button 310. The history control unit 203 transmits the job ID obtained from the history information to the job information management unit 204. The job information management unit 204 reads the job information corresponding to the job ID, and transmits the read job information to the history control unit 203. Here, the job information having the job ID “JOB001” illustrated in FIG. 4A is obtained as the job information corresponding to the job ID “JOB001” obtained from the history information having the history ID “H001”.

In step S803, the history control unit 203 transmits the function ID and the job settings included in the job information obtained in step S802 to the menu function control unit 201, and requests the menu function control unit 201 to call the function corresponding to the function ID with the specified job settings. The menu function control unit 201 requests the menu display unit 202 to display the screen of the function corresponding to the received function ID, with the received job settings reflected thereon. Here, the “copy” function having a function ID “APP003” corresponding to the job ID “JOB001” in FIG. 4A is called with the job settings corresponding to the job ID “JOB001”. The menu display unit 202 displays the requested menu screen on the display 121.

In step S804, the menu function control unit 201 receives an instruction to execute the “copy” function, issued by the user on the menu screen, via the menu display unit 202, and obtains the job settings input on the menu screen. When the user issues the instruction to execute the “copy” function here, the setting contents and the document to be processed may be different from the job settings displayed on the menu screen of the “copy” function in step S803, i.e., the job settings specified by the user in step S602 of FIG. 6 and the specified document to be processed. In other words, by using the flowcharts of FIGS. 6 and 8 according to the first exemplary embodiment, the same job settings as those of the function instructed to be executed in step S602 are displayed in the menu display region 301 displayed in step S803. The subsequent operations are similar to those of the steps designated by the same reference numerals in FIG. 6.

Through the operations of steps S603 and S604, the job is executed and the history is added. The job information having a job ID “JOB002” in FIG. 4A is thereby registered and the history information having a history ID “H002” in FIG. 5A is registered. As a result, the history button 322 illustrated in FIG. 3C is displayed. The information processing ends.

Next, an operation of the image forming apparatus 101 according to the first exemplary embodiment will be described with reference to FIG. 9. FIG. 9 is a flowchart illustrating information processing of the image forming apparatus 101 according to the first exemplary embodiment, where the original image generation unit 208 of the document image generation unit 207 generates an original image as a document image based on a request from the history control unit 203. The operations in steps of FIG. 9 are processed by the CPU 111 executing a program stored in the ROM 113 or the external memory 122.

In step S901, the original image generation unit 208 of the document image generation unit 207 receives an original image generation request from the history control unit 203, and receives job information. In the following description, the received job information will be referred to simply as job information.

In step S902, the original image generation unit 208 determines whether the job type included in the job information includes scan. If the original image generation unit 208 determines that scan is included (YES in step S902), the processing proceeds to step S903. If not (NO in step S902), the processing proceeds to step S905.

In step S903, the original image generation unit 208 determines whether the job settings included in the job information include book to 2 pages. If the original image generation unit 208 determines that book to 2 pages is included (YES in step S903), the processing proceeds to step S904. If not (NO in step S903), the processing proceeds to step S905.

In step S904, the original image generation unit 208 determines whether the number of pages in the job result included in the job information is two or more. If the original image generation unit 208 determines that the number of pages is two or more (YES in step S904), the processing proceeds to step S907. If not (NO in step S904), the processing proceeds to step S905.

In step S905, the original image generation unit 208 reads and obtains the first pre-processing image among the pre-processing images listed in the job information from the external memory 122.

In step S906, the original image generation unit 208 adds the first pre-processing image obtained in step S905 as a front cover image of the original image.

In step S907, the original image generation unit 208 reads and obtains the first and second pre-processing images among the pre-processing images listed in the job information from the external memory 122.

In step S908, the original image generation unit 208 reduces and combines the first and second pre-processing images obtained in step S907 into one image, and adds the image as a front cover image of the original image.

In step S909, the original image generation unit 208 obtains the number of pages in the job result included in the job information.

In step S910, the original image generation unit 208 determines whether the job type included in the job information includes scan. If the original image generation unit 208 determines that scan is included (YES in step S910), the processing proceeds to step S911. If not (NO in step S910), the processing proceeds to step S915.

In step S911, the original image generation unit 208 determines whether the layout specified in the job settings included in the job information is two-sided. If the original image generation unit 208 determines that the layout is two-sided (YES in step S911), the processing proceeds to step S912. If not (NO in step S911), the processing proceeds to step S913.

In step S912, the original image generation unit 208 changes the number of pages in the job result included in the job information to one half.

In step S913, the original image generation unit 208 determines whether the job settings included in the job information include book to 2 pages. If the original image generation unit 208 determines that book to 2 pages is included (YES in step S913), the processing proceeds to step S914. If not (NO in step S914), the processing proceeds to step S915.

In step S914, the original image generation unit 208 changes the number of pages in the job result included in the job information to twice the number of pages.

In step S915, the original image generation unit 208 adds a thickness image corresponding to the number of pages in the job result to the original image based on the number of pages in the job result included in the job information. If the number of pages here includes a fraction after the decimal point, the number of pages is rounded up to an integer. While a thickness image corresponding to the number of pages is added here to the original image, an image indicating the numerical value of the number of pages may be added to the original image instead of the thickness image.

In step S916, the original image generation unit 208 returns the generated original image to the history control unit 203 as a document image. The information processing ends.

The first exemplary embodiment has been described above. Some conventional image forming apparatuses display job information in the form of history buttons as illustrated in FIG. 3A. In such a case, to select a function to be re-executed from among the history buttons displayed in the history display region 308, the user needs to memorize the function name or the setting contents in advance and recall the function to be re-executed based on the functions or setting contents displayed as histories. Some users remember executed functions not by function name or setting contents but in terms of the documents to be processed used when the functions are executed. Such users may have difficulty in recalling the function to be re-executed and selecting the history button for re-execution even if the function name and the setting contents are displayed on the history button as illustrated in FIG. 3A.

Through the procedure described above, the history control unit 203 requests the job information management unit 204 to store the job information about the function executed by the menu function control unit 201 and the paths of the pre- and post-processing images into the job information table illustrated in FIG. 4A. The history control unit 203 instructs the original image generation unit 208 of the document image generation unit 207 to generate an original image representing the original as a document image, and requests the history information management unit 205 to store the history information and the path of the original image into the history information table illustrated in FIG. 5A. The history control unit 203 then requests the history display unit 211 to display the history button 310 in the history display region 308 of the main screen 300 on the display 121. Here, the history button 310 displays the original image as the history original image 321. The history control unit 203 detects via the history display unit 211 that the history button 310 is selected by the user. The history control unit 203 obtains the history information corresponding to the history button 310 from the history information management unit 205, and the job information corresponding to the job ID included in the history information from the job information management unit 204. The history control unit 203 transmits the job information to the menu function control unit 201 and requests the menu function control unit 201 to call the function corresponding to the job information. The menu function control unit 201 displays the menu screen of the function corresponding to the received job information, with the job settings included in the job information reflected thereon. Through such processing, the original image is displayed on the history button 310 as the document image. This enables the user who remembers the executed function in terms of the document, as processing object, used when the function is executed to recall the function to be re-executed by referring to the original image that is the document image, and facilitates the user to select the history button for re-execution.

A second exemplary embodiment will be described. In the first exemplary embodiment, displaying the original image as the document image enables even the user who remembers the executed function in terms of the document used when the function is executed to recall the function to be re-executed and select the history button for re-execution by referring to the original image. The second exemplary embodiment describes an example of processing for displaying an image of a product on the history button as the document image. In the second exemplary embodiment, components, steps, and processing designated by the same reference numerals as in the first exemplary embodiment are similar to those designated by the same reference numerals in the first exemplary embodiment unless otherwise specified.

FIG. 3D illustrates an example of the main screen 300 before job re-execution according to the second exemplary embodiment. Descriptions of buttons and display items not related to the second exemplary embodiment will be omitted. In the second exemplary embodiment, display contents designated by the same reference numerals as in FIGS. 3A to 3C are similar to those in FIGS. 3A to 3C unless otherwise specified. A difference of FIG. 3D from FIGS. 3A to 3C is that a history button 330 is displayed instead of the history buttons 310, 314, 316, 318, and 322. The history button 330 is one that displays a history of use of a “box print” function in the past and is intended to re-execute the “box print” function with the same job settings as in the past based on the history. A history function display 331 indicates the function name of the executed function, included in the history information. A history job setting display 332 indicates the contents of the job settings of the executed job, included in the history information. In FIG. 3D, a history document display 333 and a history product image 334 are displayed instead of the history document display 320 and the history original image 321 in FIG. 3B. The history document display 333 displays an image of a document used in the job executed when the history button 330 is registered. In the second exemplary embodiment, as the image of the document used in the job, the history document display 333 displays the history product image 334 schematically representing a product that is output as a job result. The history product image 334 is an image schematically representing the product that is output as a result of the job executed when the history button 330 is registered. The history product image 334 schematically represents a front cover of the product, a thickness image indicating the number of sheets of the product printed when the “box print” function is executed, and a copy number image indicating the number of copies of the product. The history product image 334 does not need to be an image that faithfully represents the product. For example, the thickness and the number of copies of the product may be displayed by numerical representations of the number of sheets, the number of pages, and the number of copies of the product instead of the thickness image and the copy number image.

FIG. 3E illustrates an example of the main screen 300 after job re-execution according to the second exemplary embodiment. Descriptions of buttons and display items not related to the second exemplary embodiment will be omitted. In FIG. 3E, display items designated by the same reference numerals as in FIGS. 3A to 3D are similar to those in FIGS. 3A to 3D unless otherwise specified. A difference from FIG. 3D is that a history button 335 is displayed in addition to the history button 330. In other words, in FIG. 3E, the main screen 300 displays one additional history button, i.e., two history buttons, as a state after job execution. The history button 335 is one that displays a history of execution of a job of the “box print” function and is intended to re-execute the “box print” function with the same job settings as in the past based on the history.

FIGS. 4A to 4E illustrate examples of the job information table. The second exemplary embodiment will be described with reference to FIG. 4B. FIGS. 5A to 5E illustrate examples of the history information table. The second exemplary embodiment will be described with reference to FIG. 5B.

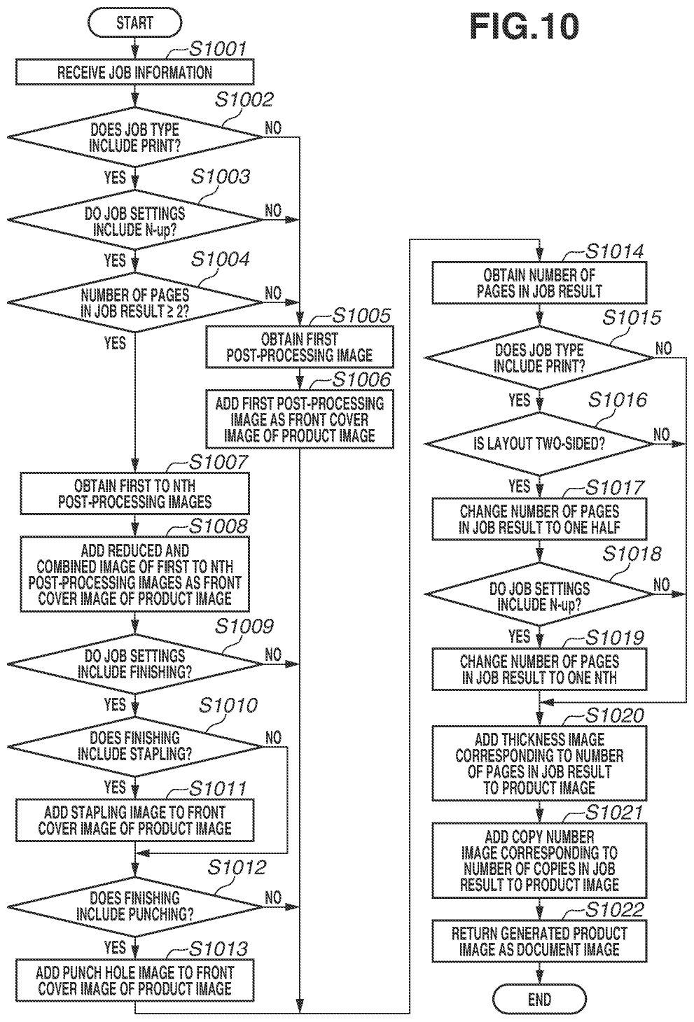

Next, an operation of the image forming apparatus 101 according to the second exemplary embodiment will be described with reference to FIG. 7B. FIG. 7B is a flowchart illustrating information processing of the image forming apparatus 101 according to the second exemplary embodiment, where the history control unit 203 performs history addition processing when a history addition processing request from the menu function control unit 201 is received. The operations in steps of FIG. 7B are processed by the CPU 111 executing a program stored in the ROM 113 or the external memory 122. A difference from FIG. 7A is that the history control unit 203 transmits the job information to the product image generation unit 209 of the document image generation unit 207, requests the product image generation unit 209 to generate a product image, and obtains the product image from the product image generation unit 209 in step S711 instead of step S705. In the second exemplary embodiment, in the case of the job 1D “JOB011” in FIG. 4B, the history control unit 203 generates an image like the history product image 334 illustrated in FIG. 3D. Details of such processing (product image generation processing) will be described with reference to FIG. 10.

An operation of the image forming apparatus 101 according to the second exemplary embodiment will be described with reference to FIG. 10. FIG. 10 is a flowchart illustrating information processing of the image forming apparatus 101 according to the second exemplary embodiment, where the product image generation unit 209 of the document image generation unit 207 generates a product image as a document image based on a request from the history control unit 203. The steps of FIG. 10 are processed by the CPU 111 executing a program stored in the ROM 113 or the external memory 122.

In step S1001, the product image generation unit 209 of the document image generation unit 207 receives a product image generation request from the history control unit 203, and receives job information. In the following description, the received job information will be referred to simply as job information.

In step S1002, the product image generation unit 209 determines whether the job type included in the job information includes print. If the product image generation unit 209 determines that print is included (YES in step S1002), the processing proceeds to step S1003. If not (NO in step S1002), the processing proceeds to step S1005.

In step S1003, the product image generation unit 209 determines whether the job settings included in the job information include N-up. If the product image generation unit 209 determines that N-up is included (YES in step S1003), the processing proceeds to step S1004. If not (NO in step S1003), the processing proceeds to step S1005.

In step S1004, the product image generation unit 209 determines whether the number of pages in the job result included in the job information is two or more. If the product image generation unit 209 determines that the number of pages is two or more (YES in step S1004), the processing proceeds to step S1007. If not (NO in step S1004), the processing proceeds to step S1005.

In step S1005, the product image generation unit 209 reads and obtains the first post-processing image among the post-processing images listed in the job information from the external memory 122.

In step S1006, the product image generation unit 209 adds the first post-processing image obtained in step S1005 as a front cover image of the product image.

In step S1007, the product image generation unit 209 reads and obtains the first to (N-up number)th (Nth) post-processing images among the post-processing images listed in the job information from the external memory 122. For example, in the case of the job ID “JOB011” in FIG. 4B, N-up specified in the job settings included in the job information is “2 in 1”. The N-up number, or N, is “2”. In step S1007, the product image generation unit 209 thus reads and obtains the first to “second” post-processing images from the external memory 122.

In step S1008, the product image generation unit 209 reduces and combines the first to Nth post-processing images obtained in step S1007 into one image, and adds the image as the front cover image of the product image.

In step S1009, the product image generation unit 209 determines whether the job settings include finishing. If the product image generation unit 209 determines that the job settings include finishing (YES in step S1009), the processing proceeds to step S1010. If not (NO in step S1009), the processing proceeds to step S1014.

In step S1010, the product image generation unit 209 determines whether the finishing included in the job settings includes stapling. If the product image generation unit 209 determines that stapling is included (YES in step S1010), the processing proceeds to step S1011. If not (NO in step S1010), the processing proceeds to step S1012.

In step S1011, the product image generation unit 209 adds a stapling image schematically representing stapling to the front cover image of the product image. While the history product image 334 illustrated in FIG. 3D displays a stapling image at the top left position, the stapling image may be added to a position other than the top left based on the job settings included in the job information. A plurality of stapling images may be added based on the number of stapling positions.

In step S1012, the product image generation unit 209 determines whether the finishing included in the job information includes punching. If the product image generation unit 209 determines that punching is included (YES in step S1012), the processing proceeds to step S1013. If not (NO in step S1012), the processing proceeds to step S1014.

In step S1013, the product image generation unit 209 adds a punch hole image schematically representing punching to the front cover image of the product image. Here, a punch hole image is added based on the position(s) and number of punch holes specified in the job settings included in the job information. In steps S1010 to S1013, the product image generation unit 209 adds a stapling image(s) and/or a punch hole image if the finishing included in the job settings includes stapling and/or punching. If the job settings include other bookbinding processing than stapling and punching as the finishing, images corresponding to the finishing may be added to the front cover image.

In step S1014, the product image generation unit 209 obtains the number of pages in the job result included in the job information.

In step S1015, the product image generation unit 209 determines whether the job type included in the job information includes print. If the product image generation unit 209 determines that print is included (YES in step S1015), the processing proceeds to step S1016. If not (NO in step S1015), the processing proceeds to step S1020.

In step S1016, the product image generation unit 209 determines whether the layout specified in the job settings included in the job information is two-sided. If the product image generation unit 209 determines that the layout is two-sided (YES in step S1016), the processing proceeds to step S1017. If not (NO in step S1016), the processing proceeds to step S1020.

In step S1017, the product image generation unit 209 changes the number of pages in the job result included in the job information to one half.

In step S1018, the product image generation unit 209 determines whether the job settings included in the job information include N-up. If the product image generation unit 209 determines that N-up is included (YES in step S1018), the processing proceeds to step S1019. If not (NO in step S1018), the processing proceeds to step S1020.

In step S1019, the product image generation unit 209 changes the number of pages in the job result included in the job information to one Nth.

In step S1020, the product image generation unit 209 adds a thickness image corresponding to the number of pages in the job result to the product image based on the number of pages in the job result included in the job information. If the number of pages here includes a fraction after the decimal point, the number of pages is rounded up to an integer. While a thickness image corresponding to the number of pages is added here to the product image, an image indicating the numerical value of the number of pages may be added to the product image instead of the thickness image.

In step S1021, the product image generation unit 209 adds a copy number image corresponding to the number of copies in the job result to the product image based on the number of copies in the job result included in the job information.

In step S1022, the product image generation unit 209 returns the generated product image to the history control unit 203 as the document image. The information processing ends.

The second exemplary embodiment has been described above. Some conventional image forming apparatuses display job information in the form of history buttons as illustrated in FIG. 3A. Some users remember executed functions not by function name or setting contents but in terms of the processing-target documents used when the functions are used. Such users may have difficulty in recalling the function to be re-executed and selecting the history button for re-execution even if the function name and the setting contents are displayed on the history button as illustrated in FIG. 3A. In the first exemplary embodiment, the original image is displayed on the history button as the document image. However, to recall the history button for re-execution, an image representing the product can sometimes be more appropriate than that representing the original. Examples of such cases include when a history of execution of a job for printing document data stored in, for example, the external memory 122 of the image forming apparatus 101, as in the “box print” job in the second exemplary embodiment, is displayed.

Through the procedure described above, the history control unit 203 requests the job information management unit 204 to store the job information about the job executed by the menu function control unit 201 and the paths of the pre- and post-processing images into the job information table illustrated in FIG. 4B. The history control unit 203 instructs the product image generation unit 209 of the document image generation unit 207 to generate a product image representing the product as a document image, and requests the history information management unit 205 to store the history information and the path of the product image into the history information table illustrated in FIG. 5B. The history control unit 203 requests the history display unit 211 to display the history button 330 in the history display region 308 of the main screen 300 on the display 121. Here, the history button 330 displays the product image as the history product image 334. Through such operations, the product image is displayed on the history button 330 as the document image. This enables the user who remembers the executed function in terms of the processing-target document used when the function is executed to recall the function to be re-executed by referring to the product image that is the document image, and facilitates the user to select the history button for re-execution.

Next, a third exemplary embodiment will be described. In the first exemplary embodiment, an original image is displayed as the document image. In the second exemplary embodiment, a product image is displayed as the document image. The third exemplary embodiment deals with an example of processing for displaying a product image on a history button as the document image in addition to an original image. In the third exemplary embodiment, components, steps, and processing designated by the same reference numerals as in the first and second exemplary embodiments are similar to those in the first and second exemplary embodiments unless otherwise specified.

FIG. 3F illustrates an example of the main screen 300 before job re-execution according to the third exemplary embodiment. Descriptions of buttons and display items not related to the third exemplary embodiment will be omitted. In the third exemplary embodiment, display contents designated by the same reference numerals as in FIGS. 3A to 3E are similar to those in FIGS. 3A to 3E unless otherwise specified. A difference of FIG. 3F from FIGS. 3A to 3E is that a history button 340 is displayed instead of the history buttons 310, 314, 316, 318, 322, 330, and 335. The history button 340 is one that displays a history of use of the “copy” function in the past and is intended to re-execute the “copy” function with the same job settings as in the past based on the history. A history function display 341 indicates the function name of the executed function, included in the history information. A history job setting display 342 indicates the contents of the job settings of the executed job, included in the history information. In FIG. 3F, a history document display 343 and a history original and product image 344 are displayed instead of the history document display 320 and the history original image 321 in FIG. 3B. The history document display 343 displays an image of a document used in the job executed when the history button 340 is registered. In the third exemplary embodiment, as the image of the document used in the job, the history document display 343 displays the history original and product image 344 schematically representing the original used as a job input and the product output as a result of the job. The history original and product image 344 is an image schematically representing the original used as the input to the job executed when the history button 340 is registered and the product output as a result of the job. The history original and product image 344 includes an original image that schematically represents a front cover of the original and a thickness image indicating the number of sheets of the original that is input when the “copy” function is executed. The history original and product image 344 further includes a product image that schematically represents a front cover of the product, a thickness image indicating the number of sheets of the product printed when the “copy” function is executed, and a copy number image indicating the number of copies of the product. Neither the original image nor the product image needs to be an image that faithfully represents the original or product. For example, the thickness and the number of copies of the original or product may be indicated by numerical representations of the number of sheets, the number of pages, and the number of copies of the original or product instead of the thickness image and the copy number image.

FIG. 3G illustrates an example of the main screen 300 after job re-execution according to the third exemplary embodiment. Descriptions of buttons and display items not related to the third exemplary embodiment will be omitted. In FIG. 3G, display contents designated by the same reference numerals as in FIGS. 3A to 3F are similar to those in FIGS. 3A to 3F unless otherwise specified. A difference from FIG. 3F is that a history button 345 is displayed in addition to the history button 340. In other words, in FIG. 3G, the main screen 300 displays one additional history button, i.e., two history buttons, as a state after job execution. The history button 345 is one that displays a history of execution of a job of the “copy” function and is intended to re-execute the “copy” function with the same job settings as in the past based on the history.

FIGS. 4A to 4E illustrate examples of the job information table. The third exemplary embodiment will be described with reference to FIG. 4C. FIGS. 5A to 5E illustrate examples of the history information table. The third exemplary embodiment will be described with reference to FIG. 5C.

Next, an operation of the image forming apparatus 101 according to the third exemplary embodiment will be described with reference to FIG. 7C. FIG. 7C is a flowchart illustrating information processing of the image forming apparatus 101 according to the third exemplary embodiment, where the history control unit 203 performs history addition processing when a history addition processing request from the menu function control unit 201 is received. The operations of steps in FIG. 7C are processed by the CPU 111 executing a program stored in the ROM 113 or the external memory 122. A difference from FIG. 7A is that the operations of steps S721 to S724 (described below) is added after step S705.

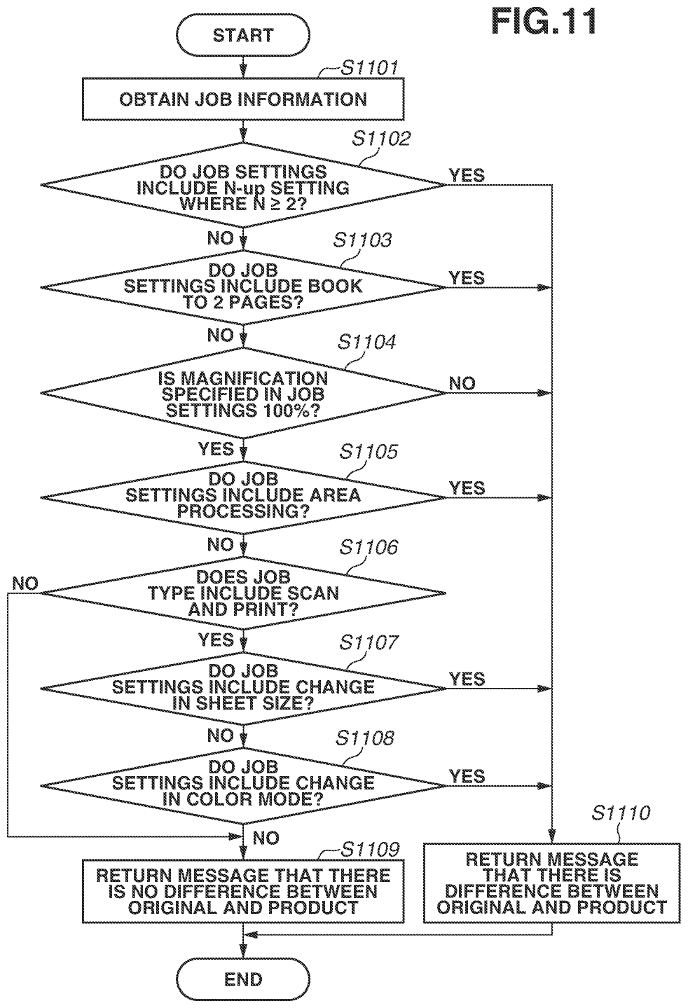

In step S721, the history control unit 203 performs original and product difference determination processing for determining whether there is a difference between the original and the product. Details of the original and product difference determination processing will be described with reference to FIG. 11.

In step S722, the history control unit 203 determines where there is a difference between the original and the product based on the result of the original and product difference determination processing in step S721. If the history control unit 203 determines that there is a difference (YES in step S722), the processing proceeds to step S723. If not (NO in step S722), the processing proceeds to step S706.

In step S723, the history control unit 203 performs product image generation processing for generating a product image from the job information. This processing is similar to that in step S711 of FIG. 7B. Since details of the product image generation processing has been described with reference to FIG. 10, a description thereof will be omitted.

In step S724, the history control unit 203 transmits the original image obtained in step S721 and the product image obtained in step S723 to the original and product image generation unit 210 of the document image generation unit 207, and requests the original and product image generation unit 210 to generate an original and product image. The original and product image generation unit 210 generates an original and product image by adding the received product image to the received original image, and transmits the original and product image to the history control unit 203. The history control unit 203 obtains the original and product image.

Next, an operation of the image forming apparatus 101 according to the third exemplary embodiment will be described with reference to FIG. 11. FIG. 11 is a flowchart illustrating the original and product difference determination processing of the image forming apparatus 101 according to the third exemplary embodiment, where the history control unit 203 determines whether there is a difference between the original and the product of a job. The operations of steps in FIG. 11 are processed by the CPU 111 executing a program stored in the ROM 113 or the external memory 122.

In step S1101, the history control unit 203 obtains the target job information of the original and product difference determination processing. Suppose here that the history control unit 203 obtains the job information having a job ID “JOB021” in FIG. 4C.

In step S1102, the history control unit 203 determines whether the job settings included in the job information include an N-up setting where the N-up number, or N, is greater than or equal to 2. In other words, the history control unit 203 determines whether 2 in 1, or 2-up, or higher is set. If the history control unit 203 determines that the condition is satisfied (YES in step S1102), the processing proceeds to step S1110. If not (NO in step S1102), the processing proceeds to step S1103.

In step S1103, the history control unit 203 determines whether the job settings included in the job information include book to 2 pages. If the history control unit 203 determines that book to 2 pages is included (YES in step S1103), the processing proceeds to step S1110. If not (NO in step S1103), the processing proceeds to step S1104.

In step S1104, the history control unit 203 determines whether the magnification specified in the job settings included in the job information is 100%. If the history control unit 203 determines that the magnification is not 100% (NO in step S1104), the processing proceeds to step S1110. If the history control unit 203 determines that the magnification is 100% (YES in step S1104), the processing proceeds to step S1105.

In step S1105, the history control unit 203 determines whether the job settings included in the job information include area processing. If the history control unit 203 determines that area processing is included (YES in step S1105), the processing proceeds to step S1110. If not (NO in step S1105), the processing proceeds to step S1106. As employed herein, the area processing refers to image processing, such as trimming, masking, and negative/positive reversal.

In step S1106, the history control unit 203 determines whether the job type included in the job information includes scan and print. If the history control unit 203 determines that the condition is satisfied (YES in step S1106), the processing proceeds to step S1107. If not (NO in step S1106), the processing proceeds to step S1109.

In step S1107, the history control unit 203 determines whether the job settings included in the job information include a change in sheet size. If the history control unit 203 determines that a change in sheet size is included (YES in step S1107), the processing proceeds to step S1110. If not (NO in step S1107), the processing proceeds to step S1108.

In step S1108, the history control unit 203 determines whether the job settings included in the job information include a change in color mode. If the history control unit 203 determines that a change in color mode is included (YES in step S1108), the processing proceeds to step S1110. If not (NO in step S1108), the processing proceeds to step S1109.

In step S1109, the history control unit 203 returns a message indicating that there is no difference between the original and the product as the result of the original and product difference determination processing.

In step S1110, the history control unit 203 returns a message indicating that there is a difference between the original and the product as the result of the original and product difference determination processing. The original and product difference determination processing ends.

The third exemplary embodiment has been described above. In the first exemplary embodiment, an original image is displayed as the document image. In the second exemplary embodiment, a product image is displayed as the document image. Suppose that there is a plurality of histories where the products are the same but the originals are different. The document images displayed as histories in the first exemplary embodiment are original images, all of which are the same in this case. Suppose now that there is a plurality of histories where the originals are the same but the products are different. The document images displayed as histories in the second exemplary embodiment are product images, all of which are the same in this case. In other words, the user may have difficulty in distinguishing different documents and selecting a history for re-execution if either original images or product images alone are displayed as the document images in the first or second exemplary embodiment.

Through the procedure described above, the history control unit 203 instructs the original image generation unit 208 of the document image generation unit 207 to generate an original image representing the original as a document image. The history control unit 203 then performs the original and product difference determination processing to determine whether there is a difference between the original and the product based on the job information. If the history control unit 203 determines that there is a difference between the original and the product, the history control unit 203 instructs the product image generation unit 209 of the document image generation unit 207 to generate a product image representing the product as a document image. The history control unit 203 instructs the original and product image generation unit 210 of the document image generation unit 207 to generate an original and product image by adding the product image to the original image. The history control unit 203 then requests the history display unit 211 to display the history button 340 in the history display region 308 of the main screen 300 on the display 121. The history button 340 here displays the original and product image as the history original and product image 344. Through such processing, the original and product image 344 is displayed on the history button 340 as a document image. This enables the user to distinguish different documents and select a history for re-execution by referring to the original and product images even if there is a plurality of histories with the same originals or products.

Next, a fourth exemplary embodiment will be described. In the first to third exemplary embodiments, each history displays either one or both of an original image and a product image as a document image. There is an issue that if a plurality of histories is displayed, displaying document images for all the histories increases the user's scroll operations and complicates operations due to the limited display area of the display 121. An exemplary embodiment for omitting history job setting displays of histories including the same job settings in such a case will be described. The fourth exemplary embodiment will be described based on the processing for displaying an original image as the document image according to the first exemplary embodiment, whereas the fourth exemplary embodiment is also applicable to the cases of displaying a product image or an original and product image according to the second and third exemplary embodiments. In the fourth exemplary embodiment, components, steps, and processing designated by the same reference numerals as in the first to third exemplary embodiments are similar to those in the first to third exemplary embodiments unless otherwise specified.

FIG. 3H illustrates an example of the main screen 300 before job execution according to the fourth exemplary embodiment. Descriptions of buttons and display items not related to the fourth exemplary embodiment will be omitted. In the fourth exemplary embodiment, display contents designated by the same reference numerals as in FIGS. 3A to 3G are similar to those in FIGS. 3A to 3G unless otherwise specified. A difference of FIG. 3H from FIGS. 3A to 3G is that history buttons 350 and 354 are displayed instead of the history buttons 310, 314, 316, 318, 322, 330, 335, 340, and 345. The history button 350 is one that displays a history of use of the “copy” function in the past and is intended to re-execute the “copy” function with the same job settings as in the past based on the history. A history function display 351 indicates the function name of the executed function, included in the history information. A history job setting display 352 displays the contents of the job settings of the executed job, included in the history information. In FIG. 3H, a history document display 353 is displayed instead of the history document display 320 in FIG. 3B. The history document display 353 displays an image of a document used in the job executed when the history button 350 is registered. The history button 354 is one that displays a history of use of the “copy” function in the past and is intended to re-execute the “copy” function with the same job settings as in the past based on the history.

FIG. 3I illustrates an example of the main screen 300 after job execution according to the fourth exemplary embodiment. Descriptions of buttons and display items not related to the fourth exemplary embodiment will be omitted. In FIG. 3I, display contents designated by the same reference numerals as in FIGS. 3A to 3H are similar to those in FIGS. 3A to 3H unless otherwise specified. A difference from FIG. 3H is that a history document display 355 is added to the history button 350 in addition to the history document display 353. In other words, in FIG. 3I, the main screen 300 displays an additional abbreviated history, i.e., two history document displays, in the history button 350 as a state after job execution. The history document display 355 displays an image of the original used when the job is executed with the same job settings as when the history button 350 is registered.

FIGS. 4A to 4E illustrate examples of the job information table. The fourth exemplary embodiment will be described with reference to FIG. 4D. FIGS. 5A to 5E illustrate examples of the history information table. The fourth exemplary embodiment will be described with reference to FIG. 5D.

Next, an operation of the image forming apparatus 101 according to the fourth exemplary embodiment will be described with reference to FIG. 7D. FIG. 7D is a flowchart illustrating information processing of the image forming apparatus 101 according to the fourth exemplary embodiment, where the history control unit 203 performs history addition processing when a history addition processing request from the menu function control unit 201 is received. The steps of FIG. 7D are processed by the CPU 111 executing a program stored in the ROM 113 or the external memory 122. A difference from FIG. 7A is that the processing of steps S731 to S734 to be described below is added after step S706.

In step S731, the history control unit 203 requests the history information management unit 205 to obtain already registered pieces of history information stored in the history information table of FIG. 5D and obtain the job IDs included in the history information. Suppose that in FIG. 5D, only the history information having the history IDs “H031” and “H032” is registered here. The history control unit 203 obtains the history information and job IDs “JOB031” and “JOB032”. Based on the obtained job IDs, the history control unit 203 requests the job information management unit 204 to obtain the job information corresponding to the job IDs, stored in the job information table of FIG. 4D. Here, the history control unit 203 obtains the job information having the job IDs “JOB031” and “JOB032” in FIG. 4D.

In step S732, the history control unit 203 determines whether there is a history with the same job settings as those included in the job information obtained in step S701 in the job information corresponding to the already registered pieces of history information obtained in step S731. If the history control unit 203 determines that there is a history with the same job settings (YES in step S732), the processing proceeds to step S733. If not (NO in step S732), the processing proceeds to step S734. A description will be given by using the case of FIGS. 4D and 5D as an example. Suppose that the job information having the job ID “JOB033” is obtained in step S701. In such a case, the history control unit 203 determines that the job information having the job ID “JOB031” has the same job settings. The history control unit 203 then determines that there is a history with the same job settings (which specifically is the history corresponding to the history information having the job ID “JOB031” and the history ID “H031” in FIG. 5D).

In step S733, the history control unit 203 sets the history ID of the history information having the same job settings, obtained in step S731, as an addition destination history ID of the history information to be registered. In the case of FIG. 5D, the history ID “H031” that is the history ID of the history information having the same job settings is set as the addition destination history ID of the history information having the history ID “H033”.

In step S734, the history control unit 203 requests the history information management unit 205 to store the history information into the history management table. If an addition destination history ID is set in step S733, the history control unit 203 here requests the history information management unit 205 to store the addition destination history ID into the addition destination history ID field of the history information.

In step S735, the history control unit 203 requests the history information management unit 205 to determine whether there is history information including an addition destination history ID in the history information table of FIG. 5D. If the history information management unit 205 determines that there is history information including an addition destination history ID (YES in step S735), the processing proceeds to step S736. If not (NO in step S735), the processing proceeds to step S708.

In step S736, the history control unit 203 displays the histories in the history display region 308 of the main screen 300 in FIG. 3I. In displaying the history information including an addition destination history ID, the history control unit 203 displays an additional original image on the history button corresponding to the addition destination history ID. In other respects, the operation of step S736 is similar to that of step S708. A description thereof will thus be omitted.

The fourth exemplary embodiment has been described above. In the first to third exemplary embodiments, each history displays either one or both of an original image and a product image as a document image. Displaying the document image on the history button in addition to the history function display and the history job setting display increases the display area of the history button. If a plurality of histories is displayed. displaying document images on all the history buttons displayed in the history display region 308 reduces the number of history buttons that can be displayed at a time due to the limited display area of the display 121. There is therefore an issue of increased scroll operations and complicated operations by the user.

Through the procedure described above, the history control unit 203 determines during the history addition processing whether there is a history having the same job settings in the existing histories. If there is such a history, the history control unit 203 sets and stores the history ID of the history information including the same job settings as the addition destination history ID of the history information to be registered. In displaying history information including an addition destination history ID, the history control unit 203 displays only the document image on the history button corresponding to the addition destination history ID. Through such processing, if histories have the same job settings, only the document image of the history to be added can be displayed on the history button while omitting the history job setting display. This can reduce the number of history buttons to be displayed, and reduce the burden of scroll operations on the user while displaying document images on the history buttons.

Next, a fifth exemplary embodiment will be described. In the fourth exemplary embodiment, to address the issue that displaying document images for all the histories complicates user operations due to the limited display area of the display 121, the history job setting displays of histories having the same job settings are omitted. The fifth exemplary embodiment deals with a case of omitting display of document images for histories where the document images are the same, instead of omitting the history job setting displays according to the fourth exemplary embodiment. The fifth exemplary embodiment will be described based on the processing for displaying an original image as the document image according to the first exemplary embodiment, whereas the fifth exemplary embodiment is also applicable to the cases of displaying a product image or an original and product image as in the second and third exemplary embodiments. In the fifth exemplary embodiment, components, steps, and processing designated by the same reference numerals as in the first to fourth exemplary embodiments are similar to those in the first to fourth exemplary embodiments unless otherwise specified.

FIG. 3J illustrates an example of the main screen 300 before job execution according to the fifth exemplary embodiment. Descriptions of buttons and display items not related to the fifth exemplary embodiment will be omitted. In the fifth exemplary embodiment, display contents designated by the same reference numerals as in FIGS. 3A to 3I are similar to those in FIGS. 3A to 3I unless otherwise specified. A difference of FIG. 3J from FIGS. 3A to 3I is that history buttons 360 and 364 are displayed instead of the history buttons 310, 314, 316, 318, 322, 330, 335, 340, 345, 350, and 354. The history button 360 is one that displays a history of use of the “copy” function in the past and is intended to re-execute the “copy” function with the same job settings as in the past based on the history. A history function display 361 indicates the function name of the executed function, included in the history information. A history job setting display 362 indicates the contents of the job settings of the executed job, included in the history information. In FIG. 3J, a history document display 363 is displayed instead of the history document display 320 in FIG. 3B. The history document display 363 displays an image of a document used in the job executed when the history button 360 is registered. The history button 364 is one that displays a history of use of the “copy” function in the past and is intended to re-execute the “copy” function with the same job settings as in the past based on the history.

FIG. 3K illustrates an example of the main screen 300 after job execution in the fifth exemplary embodiment. Descriptions of buttons and display items not related to the fifth exemplary embodiment will be omitted. In FIG. 3K, display contents designated by the same reference numerals as in FIGS. 3A to 3J are similar to those in FIGS. 3A to 3J unless otherwise specified. A difference from FIG. 3J is that a history job setting display 366 is added to the history button 360 in addition to the history job setting display 362. In other words, in FIG. 3K, the main screen 300 displays an additional abbreviated history, i.e., two history job setting displays, in the history button 360 as a state after job execution. The history job setting display 366 displays the job settings of a job executed by using the same original or by using an original or job settings producing the same product, i.e., a job that results in the same document image as when the history button 360 is registered.

FIGS. 4A to 4E illustrate examples of the job information table. The fifth exemplary embodiment will be described with reference to FIG. 4E.

FIGS. 5A to 5E illustrate examples of the history information table. The fifth exemplary embodiment will be described with reference to FIG. 5E.

Next, an operation of the image forming apparatus 101 according to the fifth exemplary embodiment will be described with reference to FIG. 7E. FIG. 7E is a flowchart illustrating information processing of the image forming apparatus 101 according to the fifth exemplary embodiment, where the history control unit 203 performs history addition processing when a history addition processing request from the menu function control unit 201 is received. The steps of FIG. 7E are processed by the CPU 111 executing a program stored in the ROM 113 or the external memory 122. A difference from FIG. 7D is that the processing of step S741 is added instead of that of step S732, and the processing of step S742 is added instead of that of step S736.

In step S741, the history control unit 203 determines whether there is a history with the same document image as that generated through the original image generation processing of step S705 in the registered pieces of history information obtained in step S731. While the history control unit 203 here determines whether there is a history with the same document image, the history control unit 203 may determine that there is a history with the same document image if a history with a similar, but not the same, document image having a different size, position, or front cover exists. If the history control unit 203 determines that there is a history with the same document image (YES in step S741), the processing proceeds to step S733. If not (NO in step S741), the processing proceeds to step S734.

In step S742, the history control unit 203 displays the histories in the history display region 308 of the main screen 300 in FIG. 3K. In displaying history information including an addition destination history ID, the history control unit 203 displays an additional history job setting display on the history button corresponding to the addition destination history ID. In other respects, the history display processing (step S742) is similar to step S708. A description thereof will thus be omitted.

The fifth exemplary embodiment has been described above. In the first to third exemplary embodiment, each history displays either one or both of an original image and a product image as a document image. Displaying the document image on the history button in addition to the history function display and the history job setting display increases the display area of the history button. If a plurality of histories is displayed, displaying document images on all the history buttons displayed in the history display region 308 reduces the number of history buttons that can be displayed at a time due to the limited display area on the display 121. There is therefore an issue of increased scroll operations and complicated operations by the user.

Through the procedure described above, the history control unit 203 determines during the history addition processing whether there is a history having the same document image in the existing histories. If there is such a history, the history control unit 203 sets and stores the history ID of the history information including the same job settings as the addition destination history ID of the history information to be registered. In displaying history information including an addition destination history ID, the history control unit 203 displays only the history job setting display on the history button corresponding to the addition destination history ID. Through such processing, if histories have the same document images, only the history job setting display of the history to be added can be displayed on the history button while omitting the document image. This can reduce the number of history buttons to be displayed, and can reduce the burden of scroll operations on the user while displaying document images on the history buttons.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While some exemplary embodiments of the present disclosure have been described in detail above, the present disclosure is not limited to such specific exemplary embodiments.

According to the processing of the foregoing exemplary embodiments, a history display that facilitates selecting a function to be re-executed can be provided.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-018618, filed Feb. 5, 2019, which is hereby incorporated by reference herein in its entirety.

What is claimed is:

1. An image forming apparatus configured to form an image, the image forming apparatus comprising:
a generation unit configured to generate a document image based on a job setting when a function is executed and a job result when the function is executed; and
a display unit configured to display the job setting and the document image as a history of the function.

2. The image forming apparatus according to claim 1, wherein the document image is an original image representing a state of an original before execution of the function.

3. The image forming apparatus according to claim 1, wherein the document image is a product image representing a state of a product after execution of the function.

4. The image forming apparatus according to claim 1,
wherein the generation unit is configured to generate an original image representing a state of an original before execution of the function and a product image representing a state of a product after the execution of the function, and
wherein the display unit is configured to, in a case where the document image is different before and after execution of a job, display the original image and the product image as the history of the function.

5. The image forming apparatus according to claim 4, further comprising a determination unit configured to determine whether the document image is different before and after the execution of the job,
wherein the display unit is configured to, in a case where the determination unit determines that the document image is different before and after the execution of the job, display the original image and the product image as the history of the function.

6. The image forming apparatus according to claim 1, wherein the display unit is configured to, in a case where, in displaying a new history, there is a same job setting as that of the new history among job settings of histories already displayed, additionally display a document image of the new history in the history including the same job setting while omitting the job setting of the new history.

7. The image forming apparatus according to claim 6, further comprising a determination unit configured to, in displaying the new history, determine whether there is the same job setting as that of the new history among the job settings of the histories already displayed,
wherein the display unit is configured to, in a case where the determination unit determines that there is the same job setting, additionally display the document image of the new history in the history including the same job setting while omitting the job setting of the new history.

8. The image forming apparatus according to claim 1, wherein the display unit is configured to, in a case where, in displaying a new history, there is a same document image as that of the new history among document images of histories already displayed, additionally display a job setting of the new history in the history including the same document image while omitting the document image of the new history.

9. The image forming apparatus according to claim 8, further comprising a determination unit configured to, in displaying the new history, determine whether there is the same document image as that of the new history among the document images of the histories already displayed,
wherein the display unit is configured to, in a case where the determination unit determines that there is the same document image, additionally display the job setting of the new history in the history including the same document image while omitting the document image of the new history.

10. An information processing method that is performed by an image forming apparatus configured to form an image, the information processing method comprising:
generating a document image based on a job setting when a function is executed and a job result when the function is executed; and
displaying the job setting and the document image as a history of the function.

11. A non-transitory storage medium storing instructions that when executed by one or more processors control the one or more processors to:
generate a document image based on a job setting when a function is executed and a job result when the function is executed; and
display the job setting and the document image as a history of the function.
